(19) United States
(12) Patent Application Publication
(10) Pub. No.: US 2021/0144376 A1
(43) Pub. Date: May 13, 2021

(54) IMAGE PROCESSING APPARATUS AND METHOD

(71) Applicant: SONY CORPORATION, Tokyo (JP)

(72) Inventor: Takeshi TSUKUBA, Tokyo (JP)

(73) Assignee: SONY CORPORATION, Tokyo (JP)

(21) Appl. No.: 17/251,441

(22) PCT Filed: Jun. 21, 2019
(86) PCT No.: PCT/JP2019/024642

§ 371 Date: Dec. 11, 2020

(30) Foreign Application Priority Data
Jul. 6, 2018 (JP) 2018-128807

(51) Int. Cl. H04N 19/12; H04N 19/159; H04N 19/176; H04N 19/184; H04N 19/139

(52) U.S. Cl. CPC H04N 19/12; H04N 19/159; H04N 19/139; H04N 19/184; H04N 19/176

(57) ABSTRACT

There is provided an image processing apparatus and method for enabling suppression of reduction in coding efficiency. A transform type candidate table corresponding to an encoding parameter is selected from among a plurality of transform type candidate tables having different frequency characteristics of transform type candidates as elements, a transform type to be applied to a current block is set using the selected transform type candidate table, and coefficient data of the current block is inversely orthogonally transformed using a transform matrix of the set transform type. The present disclosure can be applied to, for example, an image processing apparatus, an image encoding device, an image decoding device, or the like.

### TECHNICAL FIELD

The present disclosure relates to an image processing apparatus and a method, and particularly relates to an image processing apparatus and a method for enabling suppression of reduction in coding efficiency (improvement of the coding efficiency).

### BACKGROUND ART

Conventionally, adaptive primary transform (adaptive multiple core transforms: AMT) has been disclosed regarding luminance, in which a primary transform is adaptively selected from a plurality of different orthogonal transforms for each horizontal primary transform PThor (also referred to as primary horizontal transform) and vertical primary transform PTver (also referred to as primary vertical transform) for each transform unit (TU) (for example, see Non-Patent Document 1).

In Non-Patent Document 1, there are five one-dimensional orthogonal transforms of DCT-II, DST-VII, DCT-VIII, DST-I, and DST-VII as candidates for the primary transform. Furthermore, it has been proposed to add two one-dimensional orthogonal transforms of DST-IV and identity transform (IDT: one-dimensional transform skip), and to have a total of seven one-dimensional orthogonal transforms as candidates for the primary transform (for example, see Non-Patent Document 2).

### CITATION LIST

### Non-Patent Document

Non-Patent Document 1: Jianle Chen, Elena Alshina, Gary J. Sullivan, Jens-Rainer, Jill Boyce, “Algorithm Description of Joint Exploration Test Model 4”, JVET-G1001_v1, Joint Video Exploration Team (JVET) of ITU-T SG 16 WP 3 and ISO/IEC JTC 1/SC 29/WG 11 7th Meeting: Torino, IT, 13-21 Jul. 2017
Non-Patent Document 2: V. Lorcy, P. Philippe, “Proposed improvements to the Adaptive multiple Core transform”, JVET-C0022, Joint Video Exploration Team (JVET) of ITU-T SG 16 WP 3 and ISO/IEC JTC 1/SC 29/WG 11 3rd Meeting: Geneva, CH, 26 May-1 Jun. 2016

### SUMMARY OF THE INVENTION

### Problems to be Solved by the Invention

However, in the case of these methods, frequency characteristics of transform types are not taken into consideration, and there is a risk of selecting a transform type having a frequency characteristic not suitable for a residual signal and reducing the coding efficiency.

The present disclosure has been made in view of the foregoing, and is intended to enable suppression of reduction in the coding efficiency (improvement of the coding efficiency).

### Solutions to Problems

An image processing apparatus according to one aspect of the present technology is an image processing apparatus including: a decoding unit configured to decode a bitstream to generate coefficient data obtained by orthogonally transforming a prediction residual of an image; a selection unit configured to select a transform type candidate table corresponding to an encoding parameter from among a plurality of transform type candidate tables having different frequency characteristics of transform type candidates as elements; a setting unit configured to set a transform type to be applied to a current block, using the transform type candidate table selected by the selection unit; and an inverse orthogonal transform unit configured to inversely orthogonally transform the coefficient data of the current block generated by the decoding unit, using a transform matrix of the transform type set by the setting unit.

An image processing method according to one aspect of the present technology is an image processing method including: decoding a bitstream to generate coefficient data obtained by orthogonally transforming a prediction residual of an image; selecting a transform type candidate table corresponding to an encoding parameter from among a plurality of transform type candidate tables having different frequency characteristics of transform type candidates as elements; setting a transform type to be applied to a current block, using the selected transform type candidate table; and inversely orthogonally transforming the coefficient data of the current block generated by decoding the bitstream, using a transform matrix of the set transform type.

An image processing apparatus according to another aspect of the present technology is an image processing apparatus including: a selection unit configured to select a transform type candidate table corresponding to an encoding parameter from among a plurality of transform type candidate tables having different frequency characteristics of transform type candidates as elements; a setting unit configured to set a transform type to be applied to a current block, using the transform type candidate table selected by the selection unit; an orthogonal transform unit configured to orthogonally transform a prediction residual of an image, using a transform matrix of the transform type set by the setting unit to generate coefficient data; and an encoding unit configured to encode the coefficient data generated by orthogonally transforming the prediction residual by the orthogonal transform unit to generate a bitstream.

An image processing method according to another aspect of the present technology is an image processing method including: selecting a transform type candidate table corresponding to an encoding parameter from among a plurality of transform type candidate tables having different frequency characteristics of transform type candidates as elements; setting a transform type to be applied to a current block, using the selected transform type candidate table; orthogonally transforming a prediction residual of an image, using a transform matrix of the set transform type to generate coefficient data; and encoding the coefficient data generated by orthogonally transforming the prediction residual to generate a bitstream.

In the image processing apparatus and method according to one aspect of the present technology, a bitstream is decoded to generate coefficient data obtained by orthogonally transforming a prediction residual of an image, a transform type candidate table corresponding to an encoding parameter is selected from among a plurality of transform type candidate tables having different frequency characteristics of transform type candidates as elements, a transform type to be applied to a current block is set using the selected transform type candidate table, and the coefficient data of the current block generated by decoding the bitstream is inversely orthogonally transformed using a transform matrix of the set transform type.

In an image processing apparatus and method according to another aspect of the present technology, a transform type candidate table corresponding to an encoding parameter is selected from among a plurality of transform type candidate tables having different frequency characteristics of transform type candidates as elements, a transform type to be applied to a current block is set using the selected transform type candidate table, a prediction residual of an image is orthogonally transformed using a transform matrix of the set transform type to generate coefficient data, and the coefficient data generated by orthogonally transforming the prediction residual is encoded to generate a bitstream.

### Effect of the Invention

According to the present disclosure, an image can be processed. In particular, reduction in the coding efficiency is suppressed (the coding efficiency can be improved). Note that the above-described effect is not necessarily restrictive, and any one of effects described in the present specification or any another effect obtainable from the present specification may be exhibited in addition to or in place of the above-described effect.

### BRIEF DESCRIPTION OF DRAWINGS

FIG. 1 is a diagram illustrating an example of a method for suppressing reduction in coding efficiency due to transform type setting.

FIG. 2 is a block diagram illustrating a main configuration example of a transform type derivation device.

FIG. 3 is a diagram illustrating examples of transform type candidate tables.

FIG. 4 is a flowchart for describing an example of a flow of transform type setting processing.

FIG. 5 is a flowchart for describing an example of a flow of transform type setting processing.

FIG. 6 is a diagram illustrating examples of transform type candidate tables.

FIG. 7 is a block diagram illustrating a main configuration example of a transform type derivation device.

FIG. 8 is a flowchart for describing an example of a flow of transform type setting processing.

FIG. 9 is a block diagram illustrating a main configuration example of a transform type derivation device.

FIG. 10 is a flowchart for describing an example of a flow of transform type setting processing.

FIG. 11 is a block diagram illustrating a main configuration example of a transform type derivation device.

FIG. 12 is a flowchart for describing an example of a flow of transform type setting processing.

FIG. 13 is a block diagram illustrating a main configuration example of a transform type derivation device.

FIG. 14 is a flowchart for describing an example of a flow of transform type setting processing.

FIG. 15 is a block diagram illustrating a main configuration example of an image encoding device.

FIG. 16 is a block diagram illustrating a main configuration example of an orthogonal transform unit.

FIG. 17 is a block diagram illustrating a main configuration example of a primary horizontal transform unit.

FIG. 18 is a block diagram illustrating a main configuration example of a transform matrix derivation unit.

FIG. 19 is a block diagram illustrating a main configuration example of a primary vertical transform unit.

FIG. 20 is a block diagram illustrating a main configuration example of a transform matrix derivation unit.

FIG. 21 is a flowchart for describing an example of a flow of image encoding processing.

FIG. 22 is a flowchart for describing an example of a flow of orthogonal transform processing.

FIG. 23 is a flowchart for describing an example of a flow of primary transform processing.

FIG. 24 is a flowchart for describing an example of a flow of primary horizontal transform processing.

FIG. 25 is a flowchart for describing an example of a flow of transform matrix derivation processing.

FIG. 26 is a flowchart for describing an example of a flow of primary vertical transform processing.

FIG. 27 is a block diagram illustrating a main configuration example of an image decoding device.

FIG. 28 is a block diagram illustrating a main configuration example of an inverse orthogonal transform unit.

FIG. 29 is a block diagram illustrating a main configuration example of an inverse primary vertical transform unit.

FIG. 30 is a block diagram illustrating a main configuration example of a transform matrix derivation unit.

FIG. 31 is a block diagram illustrating a main configuration example of an inverse primary horizontal transform unit.

FIG. 32 is a block diagram illustrating a main configuration example of a transform matrix derivation unit.

FIG. 33 is a flowchart for describing an example of a flow of image decoding processing.

FIG. 34 is a flowchart for describing an example of a flow of inverse orthogonal transform processing.

FIG. 35 is a flowchart for describing an example of a flow of inverse primary transform processing.

FIG. 36 is a flowchart for describing an example of a flow of inverse primary vertical transform processing.

FIG. 37 is a flowchart for describing an example of a flow of inverse primary horizontal transform processing.

FIG. 38 is a block diagram illustrating a main configuration example of a computer.

### MODE FOR CARRYING OUT THE INVENTION

Hereinafter, modes for implementing the present disclosure (hereinafter referred to as embodiments) will be described. Note that the description will be given in the following order.

1. Documents that support technical content and technical terms, or the like

2. Adaptive primary transform

3. Concept

4. First embodiment (transform type derivation device, method #1)

5. Second embodiment (transform type derivation device, method #2)

6. Third embodiment (transform type derivation device, method #3)

7. Fourth embodiment (transform type derivation device, method #4)

8. Fifth embodiment (image encoding device)

9. Sixth embodiment (image decoding device)

10. Appendix

### 1. DOCUMENTS THAT SUPPORT TECHNICAL CONTENT AND TECHNICAL TERMS, OR THE LIKE

The range disclosed by the present technology includes not only the content described in the examples but also the content described in the following non-patent documents that are known at the time of filing.
Non-Patent Document 1: (described above)
Non-Patent Document 2: (described above)
Non-Patent Document 3: TELECOMMUNICATION STANDARDIZATION SECTOR OF ITU (International Telecommunication Union), “Advanced video coding for generic audiovisual services”, H.264, April 2017
Non-Patent Document 4: TELECOMMUNICATION STANDARDIZATION SECTOR OF ITU (International Telecommunication Union), “High efficiency video coding”, H.265, December 2016

That is, the content described in the above-mentioned non-patent documents also serves as a basis for determining the support requirements. For example, the quad-tree block structure described in Non-Patent Document 4 and the quad tree plus binary tree (QTBT) block structure described in Non-Patent Document 1 fall within the disclosure range of the present technology even in the case where these pieces of content are not directly described in the examples, and satisfy the support requirements of the claims. Furthermore, for example, technical terms such as parsing, syntax, and semantics are similarly fall within the disclosure range of the present technology even in the case where these technical terms are not directly described in the examples, and satisfy the support requirements of claims.

Furthermore, in the present specification, a “block” (not a block indicating a processing unit) used for description as a partial region or a unit of processing of an image (picture) indicates an arbitrary partial region in a picture unless otherwise specified, and the size, shape, characteristics, and the like of the block are not limited. For example, the “block” includes an arbitrary partial region (unit of processing) such as a transform block (TB), a transform unit (TU), a prediction block (PB), a prediction unit (PU), a smallest coding unit (SCU), a coding unit (CU), a largest coding unit (LCU), a coding tree block (CTB), a coding tree unit (CTU), a transform block, a subblock, a macro block, a tile, or a slice, described in Non-Patent Documents 1, 3, and 4.

Furthermore, in specifying the size of such a block, not only the block size is directly specified but also the block size may be indirectly specified. For example, the block size may be specified using identification information for identifying the size. Furthermore, for example, the block size may be specified by a ratio or a difference from the size of a reference block (for example, an LCU, an SCU, or the like). For example, in a case of transmitting information for specifying the block size as a syntax element or the like, information for indirectly specifying the size as described above may be used as the information. With the configuration, the amount of information can be reduced, and the coding efficiency can be improved in some cases. Furthermore, the specification of the block size also includes specification of a range of the block size (for example, specification of a range of an allowable block sizes, or the like).

Furthermore, in the present specification, encoding includes not only the whole processing of transforming an image into a bitstream but also part of the processing. For example, encoding includes not only processing that includes prediction processing, orthogonal transform, quantization, arithmetic coding, and the like but also processing that collectively refers to quantization and arithmetic coding, processing including prediction processing, quantization, and arithmetic coding, and the like. Similarly, decoding includes not only the whole processing of transforming a bitstream into an image but also part of the processing. For example, decoding includes not only processing including inverse arithmetic decoding, inverse quantization, inverse orthogonal transform, prediction processing, and the like but also processing including inverse arithmetic decoding and inverse quantization, processing including inverse arithmetic decoding, inverse quantization, and prediction processing, and the like.

### 2. ADAPTIVE PRIMARY TRANSFORM

### Setting Transform Type

In the test model (Joint Exploration Test Model 4 (JEM4)) described in Non-Patent Document 1, adaptive primary transform (adaptive multiple core transforms (AMT)) is disclosed, in which a primary transform is adaptively selected from a plurality of different one-dimensional orthogonal transforms for each horizontal primary transform PThor (also referred to as primary horizontal transform) and vertical primary transform PTver (also referred to as primary vertical transform) regarding a luminance transform block. Note that AMT is also referred to as explicit multiple core transforms (EMT).

Specifically, regarding the luminance transform block, in a case where an adaptive primary transform flag apt_flag indicating whether or not to perform adaptive primary transform is 0 (false), discrete cosine transform (DCT)-II or discrete sine transform (DST)-VII is uniquely determined by mode information as primary transform (TrSetIdx=4).

In a case where the adaptive primary transform flag apt_flag is 1 (true) and a current coding unit (CU) including the luminance transform block to be processed is an intra CU, a transform set TrSet including orthogonal transform serving as a primary transform candidate is selected for each of a horizontal direction (x direction) and a vertical direction (y direction) from among three transform sets TrSet (TrSetIdx=0, 1, and 2). Note that the above-described DST-VII, DCT-VIII, and the like indicate types of orthogonal transform.

The transform set TrSet is uniquely determined on the basis of (intra prediction mode information of) a correspondence table of mode information and transform sets. For example, a transform set identifier TrSetIdx for specifying a corresponding transform set TrSet is set for each of transform sets TrSetH and TrSetV, as in the following expressions (1) and (2).

[Math. 1]

TrSetH=LUT_IntraModeToTrSet[IntraMode][0] (1)

TrSetV=LUT_IntraModeToTrSet[IntraMode][1] (2)

Here, TrSetH represents a transform set of the primary horizontal transform PThor, TrSetV represents a transform set of the primary vertical transform PTver, and a lookup table LUT_IntraModeToTrSet represents a correspondence table of mode information and transform sets. The first array of the lookup table LUT_IntraModeToTrSet [ ][ ] has an intra prediction mode IntraMode as an argument, and the second array has {H=0, V=1} as an argument.

For example, in a case of the intra prediction mode number 19 (IntraMode==19), a transform set of the transform set identifier TrSetIdx=0 is selected as the transform set TrSetH of the primary horizontal transform PThor (also referred to as primary horizontal transform set), and a transform set of the transform set identifier TrSetIdx=2 is selected as the transform set TrSetV of the primary vertical transform PTver (also referred to as primary horizontal transform set).

Note that, in a case where the adaptive primary transform flag apt_flag is 1 (true) and the current CU including the luminance transform block to be processed is an inter CU, the transform set InterTrSet (TrSetIdx=3) dedicated to inter CU is assigned to the transform set TrSetH of primary horizontal transform and the transform set TrSetV of primary vertical transform.

Next, which orthogonal transform of the selected transform sets TrSet is applied is selected according to a corresponding specification flag between a primary horizontal transform specification flag pt_hor_flag and a primary vertical transform specification flag pt_ver_flag, for each of the horizontal direction and the vertical direction.

For example, a transform set is derived from a predetermined transform set definition table (LUT_TrSetToTrTypeIdx), using the primary {horizontal, vertical} transform set TrSet {H, V} and the primary {horizontal, vertical} transfer specification flag pt_{hor, ver}_flag as arguments, as in the following expressions (3) and (4).

[Math. 2]

TrTypeIdx=LUT_TrSetToTrTypeIdx[TrSetH][pt_hor_flag] (3)

TrTypeIdxV=LUT_TrSetToTrTypeIdx[TrSetV][pt_ver_flag] (4)

Note that a primary transform identifier pt_idx is derived from the primary horizontal transform specification flag pt_hor_flag and the primary vertical transform specification flag pt_ver_flag on the basis of the following expression (5). That is, an upper 1 bit of the primary transform identifier pt_idx corresponds to the value of the primary vertical transform specification flag, and a lower 1 bit corresponds to the value of the primary horizontal transform specification flag.

[Math. 3]

pt_idx=(pt_ver_flag<<1)+pt_hor_flag (5)

Encoding is performed by applying arithmetic coding to a derived bin string of the primary transform identifier pt_idx to generate a bit string. Note that the adaptive primary transform flag apt_flag and the primary transform identifier pt_idx are signaled in the luminance transform block.

As described above, Non-Patent Document 1 proposes five one-dimensional orthogonal transforms of DCT-II (DCT2), DST-VII (DST7), DCT-VIII (DCT8), DST-I (DST1), and DCT-V (DCT5) as primary transform candidates. In the case where AMT is applied, a 2-bit index representing which orthogonal transform is horizontally/vertically applied is signaled from the transformation set determined by a prediction mode, and one transform is selected from the two candidates for each direction. Furthermore, Non-Patent Document 2 proposes adding two one-dimensional orthogonal transforms of DST-IV (DST4) and identity transform (IDT: one-dimensional transform skip) to the above transforms to have a total of seven one-dimensional orthogonal transforms as primary transform candidates.

### Frequency Characteristic of Transform Type

By the way, these transform types do not always have the same frequency characteristics. However, in the methods described in Non-Patent Document 1 or 2, all the prepared transform types are set as candidates without considering such frequency characteristics. Therefore, for example, there is a possibility of selecting a transform type having a frequency characteristic not suitable for a residual signal and thereby reducing the coding efficiency.

For example, when comparing the frequency characteristics of low-order basis vectors, the transform types such as DCT4, DST4, and DST2 have characteristics closer to high-pass filter characteristics (are low-pass filters closer to high-pass filters) than the transform types such as DCT8, DST7, and DST1. Furthermore, when comparing the frequency characteristics of high-order (third-order) basis vectors, the transform types such as DCT4, DST4, and DST2 have characteristics closer to low-pass filter characteristics (are high-pass filters closer to low-pass filters) than the transform types such as DCT8, DST7, and DST1. That is, the transform types such as DCT4, DST4, and DST2 can collect more high-frequency components in a lower order than the transform types such as DCT8, DST7, and DST1.

Therefore, for a residual signal containing more high-frequency components, applying the transform types such as DCT4, DST4, and DST2 can improve the coding efficiency as compared with applying the transform types such as DCT8, DST7, and DST1.

However, in the case of the method described in Non-Patent Document 1 or 2, all the transform types are selected as candidates without considering such frequency characteristics, and a desired transform type is selected from all the candidates. Therefore, there is a possibility of applying the transform types such as DCT8, DST7, and DST1 to a residual signal containing more high-frequency components, and reducing the coding efficiency as compared with the case of applying the transform types such as DCT4, DST4, and DST2.

### 3. CONCEPT

### Selection of Transform Type According to Frequency Characteristic

Therefore, a transform type is selected in consideration of the frequency characteristic of the transform type. For example, a transform type having a frequency characteristic suitable for a residual signal (coefficient data in the case of inverse orthogonal transform) that is a target to be orthogonally transformed is selected. By doing so, a transform type having a frequency characteristic according to a characteristic of a frequency components of data to be orthogonally transformed or inversely orthogonally transformed can be selected, and reduction in the coding efficiency can be suppressed (the coding efficiency can be improved).

For example, transform type candidates are divided into a plurality of groups on the basis of the frequency characteristics, and a candidate group is selected from the plurality of groups according to the characteristic of the frequency component of the residual signal (or coefficient data). By doing so, a transform type can be selected from among the transform types having the frequency characteristics suitable for the residual signal (or coefficient data) as candidates. Therefore, the transform type having the frequency characteristic according to the characteristic of the frequency component of the data to be orthogonally transformed or inversely orthogonally transformed can be more easily selected.

Note that the characteristic of the frequency component of the residual signal (or coefficient data) may be estimated on the basis of, for example, an encoding parameter. The encoding parameter for estimating the characteristic of the frequency component is arbitrary. A specific example will be described below. That is, in this case, the transform type can be selected on the basis of the encoding parameters. Therefore, the transform type having the frequency characteristic according to the characteristic of the frequency component of the data to be orthogonally transformed or inversely orthogonally transformed can be more easily selected.

### Selection of Transform Type Candidate Table

Therefore, for example, as illustrated in the “method” column in the first row from the top (except for the column of item name) in the table illustrated in FIG. 1, a transform type candidate table to be used may be selected from among a plurality of transform type candidate tables having frequency characteristics of transform types different from one another on the basis of the encoding parameters.

Here, the transform type candidate table is table information having transform type candidates in the adaptive primary transform as elements. Adaptive primary transform (selection of a transform type) is performed using the transform types included in the transform type candidate table as candidates.

As the transform type candidate table candidates, a plurality of transform type candidate tables including transform types classified according to the frequency characteristics as elements, that is, a plurality of transform type candidate tables created to make the frequency characteristics of the transform types included as elements different from one another is prepared, and a table to be used is selected from among the plurality of transform type candidate tables. That is, the frequency characteristic of the transform type to be applied is selected by the selection of the table.

That is, a transform type candidate table corresponding to an encoding parameter may be selected from among the plurality of transform type candidate tables having different frequency characteristics of transform type candidates as elements, and a transform type to be applied to a current block may be set using the selected transform type candidate table.

For example, an image processing apparatus may include a selection unit configured to select a transform type candidate table corresponding to an encoding parameter from among the plurality of transform type candidate tables having different frequency characteristics of transform type candidates as elements, and a setting unit configured to set a transform type to be applied to a current block, using the transform type candidate table selected by the selection unit.

By doing so, the transform type having the appropriate frequency characteristic (the frequency characteristic according to the characteristic of the frequency component of the data to be orthogonally transformed or inversely orthogonally transformed) can be more easily selected. Therefore, the reduction in the coding efficiency (due to the frequency characteristic of the transform type to be used being not suitable for the characteristic of the frequency component of the data to be orthogonally transformed or inversely orthogonally transformed) can be suppressed.

In other words, by doing so, the coding efficiency can be improved as compared with the case of the method of selecting the transform type without considering the frequency characteristics of the candidate transform types as described in Non-Patent Documents 1 and 2.

### Method #1

As the encoding parameter, for example, the block size of the current block to be processed may be used. For example, as illustrated in the “method” column in the second row from the top (except for the column of item name) in the table illustrated in FIG. 1, the transform type candidate table may be selected on the basis of the block size (method #1).

In general, a region in which the block size is set to be small has a large change in an image to be encoded in a spatial direction and contains a larger amount of high-frequency components than a region in which the block size is set to be large. Therefore, to such a small block, it is desirable to apply a transform type having a frequency characteristic capable of collecting more high-frequency components in a low order. In other words, for a large block, it is desirable to apply a transform type having a frequency characteristic capable of collecting more low-frequency components in a low order.

Therefore, as described above, by selecting the transform type candidate table on the basis of the block size of the current block, the reduction in the coding efficiency (due to the frequency characteristic of the transform type to be used being not suitable for the characteristic of the frequency component of the data to be orthogonally transformed or inversely orthogonally transformed) can be suppressed. In other words, by doing so, the coding efficiency can be improved as compared with the case of the method of selecting the transform type without considering the frequency characteristics of the candidate transform types as described in Non-Patent Documents 1 and 2.

Note that there are some cases where a transform matrix of a certain transform type can be derived from a transform matrix of another transform type (by an operation such as flip, transpose, code inversion, sampling, or the like). Therefore, by dividing the (candidate) transform types to be applied according to the block size, the transform matrix of the transform type for a small block size can be derived from the transform matrix of the transform type for a larger block size, for example.

Therefore, by doing so, the number of transform types (transform matrices) to be prepared as candidates can be reduced, and thus an increase in the size of the lookup table that stores the candidate transform matrices can be suppressed (the size can be made small). Furthermore, a calculation circuit for performing matrix calculation in the orthogonal transform processing can be commonalized between derivable transform types. Therefore, by doing so, an increase in the circuit scale can be suppressed (the circuit scale can be reduced).

### Method #2

### RD Cost (Encoding Side)

As the encoding parameter, for example, an RD cost may be used. For example, as illustrated in the “method” column in the third row from the top (except for the column of item name) in the table illustrated in FIG. 1, the transform type candidate table may be selected on the basis of the RD cost in the case of applying each transform type (method #2).

In other words, by calculating an RD cost by applying each transform type and comparing the calculated RD costs, which case of selecting a transform type using which transform type candidate table can improve the coding efficiency the most may be confirmed.

By doing so, the transform type can be selected using the transform type candidate table having the highest coding efficiency. Therefore, the reduction in the coding efficiency (due to the frequency characteristic of the transform type to be used being not suitable for the characteristic of the frequency component of the data to be orthogonally transformed or inversely orthogonally transformed) can be suppressed. In other words, by doing so, the coding efficiency can be improved as compared with the case of the method of selecting the transform type without considering the frequency characteristics of the candidate transform types as described in Non-Patent Documents 1 and 2.

### Identification Information Signal (Decoding Side)

Note that such derivation of an RD cost is possible on the encoding side but is difficult on a decoding side. Therefore, in this case, as illustrated in the “method” column in the third row from the top, identification information for identifying the selected transform type candidate table (transform type candidate table switching flag) may be transmitted (signaled) from the encoding side to the decoding side (method #2).

That is, the transform type candidate table switching flag, which is the identification information for identifying the transform type candidate table selected at the time of encoding, is used as the encoding parameter, and on the decoding side, a transform type candidate table corresponding to the transform type candidate table switching flag transmitted (signaled) from the encoding side may be selected.

By doing so, the selection of the transform type by the encoding side can be explicitly controlled. Furthermore, the decoding side is only required to select the transform type candidate table on the basis of the transform type candidate table switching flag supplied from the encoding side, thereby more easily selecting the transform type candidate table.

### Method #3

Furthermore, a transform type candidate table may be selected according to prediction accuracy. For example, as the encoding parameter regarding prediction accuracy, an inter prediction mode of a current block may be used. For example, as illustrated in the “method” column in the fourth row from the top (except for the column of item name) in the table illustrated in FIG. 1, the transform type candidate table may be selected on the basis of the inter prediction mode (method #3).

In general, in inter prediction, the prediction accuracy becomes higher as the number of predictions increases. For example, the amount of residual components becomes larger and the amount of high-frequency components included in a residual signal becomes larger in the case of mono-prediction than the case of bi-prediction. Therefore, the transform type candidate table is selected according to the number of predictions in the inter prediction mode of the current block (for example, whether the prediction is mono-prediction or bi-prediction).

For example, a transform type having a frequency characteristic capable of collecting more high-frequency components in a low order is applied to a block having a small number of predictions (mono-prediction or the like) of the inter prediction mode, and a transform type having a frequency characteristic capable of collecting more low-frequency components in a low order is applied to a block having a large number of predictions (bi-prediction or the like) of the inter prediction mode.

By doing so, the reduction in the coding efficiency (due to the frequency characteristic of the transform type to be used being not suitable for the characteristic of the frequency component of the data to be orthogonally transformed or inversely orthogonally transformed) can be suppressed. In other words, by doing so, the coding efficiency can be improved as compared with the case of the method of selecting the transform type without considering the frequency characteristics of the candidate transform types as described in Non-Patent Documents 1 and 2.

Note that the transform type candidate table may be selected on the basis of an intra prediction mode and the inter prediction mode. For example, a transform type having a frequency characteristic capable of collecting more low-frequency components in a low order is applied to the intra prediction mode, and a transform type having a frequency characteristic capable of collecting more high-frequency components in a low order is applied to the inter prediction mode. Thereby, the coding efficiency can be improved.

By the way, there are some cases where a transform matrix of a certain transform type can be derived from a transform matrix of another transform type (by an operation such as flip, transpose, code inversion, sampling, or the like). Therefore, by dividing the (candidate) transform types to be applied according to the inter prediction mode (the number of predictions), as described above, a transform matrix of the transform type for inter prediction mode having a large number of predictions can be derived from a transform matrix of the transform type for the inter prediction mode having a small number of predictions, for example. The same applies to the case of dividing the transform types to be candidates according to whether the prediction mode is the intra prediction mode or the inter prediction mode.

Therefore, by doing so, the number of transform types (transform matrices) to be prepared as candidates can be reduced, and thus an increase in the size of the lookup table that stores the candidate transform matrices can be suppressed (the size can be made small). Furthermore, a calculation circuit for performing matrix calculation in the orthogonal transform processing can be commonalized between derivable transform types. Therefore, by doing so, an increase in the circuit scale can be suppressed (the circuit scale can be reduced).

### Method #4

Furthermore, as the encoding parameter regarding the prediction accuracy, pixel accuracy of a motion vector of the current block may be used, for example. For example, as illustrated in the “method” column in the fifth row from the top (except for the column of item name) in the table illustrated in FIG. 1, the transform type candidate table may be selected on the basis of the pixel accuracy of a motion vector (method #4).

In general, the prediction accuracy becomes higher as the accuracy of a position indicated by the motion vector is finer. For example, the amount of residual components becomes larger in a case where the motion vector has integer pixel accuracy (the motion vector indicates an integer position) than a case where the motion vector has fractional pixel accuracy (the motion vector indicates a subpel position), and the amount of high-frequency components included in the residual signal becomes larger. Therefore, the transform type candidate table is selected according to the pixel accuracy of the motion vector of the current block (for example, whether the position pointed to by the motion vector is the integer pixel position or the subpel position).

For example, a transform type having a frequency characteristic capable of collecting more high-frequency components in a low order is applied to a block of the motion vector having the integer pixel accuracy, and a transform type having a frequency characteristic capable of collecting more low-frequency components in a low order is applied to a block of the motion vector having the fractional pixel accuracy.

By doing so, the reduction in the coding efficiency (due to the frequency characteristic of the transform type to be used being not suitable for the characteristic of the frequency component of the data to be orthogonally transformed or inversely orthogonally transformed) can be suppressed. In other words, by doing so, the coding efficiency can be improved as compared with the case of the method of selecting the transform type without considering the frequency characteristics of the candidate transform types as described in Non-Patent Documents 1 and 2.

Note that there are some cases where a transform matrix of a certain transform type can be derived from a transform matrix of another transform type (by an operation such as flip, transpose, code inversion, sampling, or the like). Therefore, by dividing the (candidate) transform types to be applied according to the pixel accuracy of the motion vector, the transform matrix of the transform type for finer accuracy can be derived from the transform matrix of the transform type for coarser accuracy, for example.

Therefore, by doing so, the number of transform types (transform matrices) to be prepared as candidates can be reduced, and thus an increase in the size of the lookup table that stores the candidate transform matrices can be suppressed (the size can be made small). Furthermore, a calculation circuit for performing matrix calculation in the orthogonal transform processing can be commonalized between derivable transform types. Therefore, by doing so, an increase in the circuit scale can be suppressed (the circuit scale can be reduced).

### Others

Each of the above-described methods (method #1 to method #4) can be used in combination with another method of the above-described methods (method #1 to method #4). Furthermore, each of the above-described methods (method #1 to method #4) may be used in combination with another method (a method using another encoding parameter) that has not been described. That is, the transform type candidate table to be used may be selected on the basis of a plurality of types of encoding parameters. For example, the transform type candidate table may be selected on the basis of both the block size (method #1) and the inter prediction mode (method #3).

Furthermore, the encoding parameter to be used for selecting the transform type candidate table is arbitrary and is not limited to the above-described examples.

Moreover, a plurality of methods is prepared as candidates, and any of the plurality of methods may be selected and adopted. For example, the above-described methods #1 to #4, methods not described above, combinations of a plurality of methods, and the like may be prepared as candidates, and the appropriate method may be selected from among the prepared methods. By doing so, the transform type candidate table can be selected by a more appropriate method. Therefore, the reduction in the coding efficiency can be suppressed (the coding efficiency can be improved).

Note that, in that case, the decoding side needs to adopt the same method as the method adopted on the encoding side. Therefore, information (e.g., identification information) indicating the method adopted on the encoding side may be transmitted (signaled) to the decoding side. By doing so, the decoding side can more easily select a correct method.

### 4. FIRST EMBODIMENT

### Transform Type Derivation Device (Method #1)

Next, each method will be more specifically described. First, the method #1 will be described. FIG. 2 is a block diagram illustrating an example of a configuration of a transform type derivation device as one mode of an image processing apparatus to which the present technology is applied. A transform type derivation device 100 illustrated in FIG. 2 is a device that derives a transform type used for primary transform and inverse primary transform by the above-described method #1.

As illustrated in FIG. 2, the transform type derivation device 100 includes an Emt control unit 101, a transform set identifier setting unit 102, a transform type candidate table selection unit 103, and a transform type setting unit 104.

The Emt control unit 101 has an arbitrary configuration such as a central processing unit (CPU), a read only memory (ROM), and a random access memory (RAM), for example, and performs processing regarding control of adaptive change (for example, adaptive primary transform) of the transform type of the orthogonal transform. For example, the Emt control unit 101 acquires a transform flag Emtflag (also referred to as emt_flag) input from an outside of the transform type derivation device 100. The transform flag Emtflag is a flag indicating whether or not to adaptively change the transform type of the orthogonal transform (for example, whether or not to apply the adaptive primary transform). The Emt control unit 101 controls each of the processing units (for example, the transform set identifier setting unit 102 to the transform type setting unit 104) of the transform type derivation device 100 on the basis of a value of the input transform flag Emtflag (dotted line arrows) to adaptively change or not to change the transform type of the orthogonal transform.

The transform set identifier setting unit 102 has an arbitrary configuration such as a CPU, ROM, and RAM, for example, and performs processing regarding setting of a transform set identifier trSetIdx. The transform set identifier trSetIdx is an identifier for identifying the transform set. A transform set is a set (group) of patterns of combinations of transform type candidates. Although details will be described below, the combinations of transform type candidates selectable from the transform type candidate table can be narrowed down by selecting the transform set. For example, the transform set identifier setting unit 102 acquires various types of information such as mode information, block size, and color identifier input from the outside of the transform type derivation device 100. The transform set identifier setting unit 102 derives (sets) the transform set identifier trSetIdx on the basis of the information. The transform set identifier setting unit 102 supplies the set transform set identifier trSetIdx to the transform type setting unit 104.

The transform type candidate table selection unit 103 has an arbitrary configuration such as a CPU, ROM, and RAM, for example, and performs processing regarding selection of the transform type candidate table. For example, the transform type candidate table selection unit 103 acquires information regarding the block size input from the outside of the transform type derivation device 100. Furthermore, the transform type candidate table selection unit 103 stores a transform type candidate table A111 and a transform type candidate table B112 in advance. The transform type candidate table selection unit 103 selects one of these transform type candidate tables on the basis of the acquired information regarding the block size (the block size of the current block). The transform type candidate table selection unit 103 supplies the selected transform type candidate table to the transform type setting unit 104.

For example, the transform type candidate table A111 and the transform type candidate table B112 have different frequency characteristics of transform type candidates as elements. For example, the transform type candidate table A111 includes a transform type suitable for a residual signal including more high-frequency components as elements than the transform type candidate table B112. In other words, the transform type candidate table A111 includes a transform type suitable for a smaller block as an element than the transform type candidate table B112.

The transform type candidate table B112 includes a transform type suitable for a residual signal including more low-frequency components as elements than the transform type candidate table A111. In other words, the transform type candidate table B112 includes a transform type suitable for a larger block as an element than the transform type candidate table A111.

A in FIG. 3 illustrates an example of the transform type candidate table A111. In the case of the example illustrated in A in FIG. 3, the transform type candidate table A111 includes four types of transform types of DCT2, DCT4, DST2, and DST4 as elements. Furthermore, B in FIG. 3 illustrates an example of the transform type candidate table B112. In the case of the example illustrated in B in FIG. 3, the transform type candidate table B112 includes four types of transform types of DCT2, DCT8, DST1, and DST7, as elements.

Note that DST7 and DST4 are transform types replaceable with each other. Furthermore, DCT8 and DCT4 are transform types replaceable with each other. Moreover, DST1 and DST2 are transform types replaceable with each other.

For example, regarding the frequency characteristics of low-order basis vectors, the transform types DCT4, DST2, and DST4 have stronger high-pass filter characteristics (are low-path filters closer to high-pass filters) than the transform types DCT8, DST1, and DST7. Furthermore, regarding the frequency characteristics of high-order (third-order) basis vectors, the transform types DCT4, DST2, and DST4 have stronger low-pass filter characteristics (are high-path filters closer to low-pass filters) than the transform types DCT8, DST1, and DST7. That is, the transform types DCT4, DST2, and DST4 have frequency characteristics capable of collecting more high-frequency components in a low order than the transform types DCT8, DST1, and DST7.

Therefore, the transform type candidate table selection unit 103 selects the transform type candidate table A111 in the case where the block size of the current block is smaller than a predetermined threshold (or equal to or smaller than the threshold), and selects the transform type candidate table B112 in the case where the block size of the current block is equal to or larger than a predetermined threshold (or larger than the threshold).

The transform type setting unit 104 has an arbitrary configuration such as a CPU, ROM, and RAM, for example, and performs processing regarding transform type setting. For example, the transform type setting unit 104 acquires the transform set identifier trSetIdx derived (set) by the transform set identifier setting unit 102. Furthermore, the transform type setting unit 104 acquires the transform type candidate table selected by the transform type candidate table selection unit 103. Moreover, the transform type setting unit 104 acquires a transform index EmtIdx (also referred to as emt_idx) input from the outside of the transform type derivation device 100. Furthermore, the transform type setting unit 104 acquires a primary horizontal transform specification flag pt_hor_flag and a primary vertical transform specification flag pt_ver_flag input from the outside of the transform type derivation device 100.

As illustrated in the example in FIG. 3, a transform pair can be selected from the transform type candidate table on the basis of the transform set identifier trSetIdx and the transform index EmtIdx. This transform pair includes a transform type (trTypeH) for horizontal one-dimensional orthogonal transform (or horizontal inverse one-dimensional orthogonal transform) and a transform type (trTypeV) for vertical one-dimensional orthogonal transform (or vertical inverse one-dimensional orthogonal transform).

The transform set is a set (group) of these transform pairs, and in the example in FIG. 3, the elements are arranged in a row direction (horizontal direction in FIG. 3). The transform set identifier trSetIdx identifies which row is to be selected (which transform set is to be selected) according to the value (0 to 5). That is, by specifying the transform set using the transform set identifier trSetIdx, selectable transform pairs (patterns of combinations of transform type candidates) are narrowed down.

The transform index EmtIdx is an identifier for identifying which element (transform pair) of such a transformation set is to be selected. In the case of the example in FIG. 3, the transform index EmtIdx identifies which column is to be selected (which transform pair is to be selected) according to the value (0 to 3).

The primary horizontal transform specification flag pt_hor_flag is flag information that specifies the transform type (trTypeH) for horizontal one-dimensional orthogonal transform (or horizontal inverse one-dimensional orthogonal transform) in the transform pair. The primary vertical transform specification flag pt_ver_flag is flag information that specifies the transform type (trTypeV) for vertical one-dimensional orthogonal transform (or vertical inverse one-dimensional orthogonal transform) in the transform pair.

The transform type setting unit 104 selects the transform pair specified by the transform set identifier trSetIdx set by the transform set identifier and the transform index EmtIdx in the transform type candidate table selected by the transform type candidate table selection unit 103. Then, the transform type setting unit 104 uses the primary horizontal transform specification flag pt_hor_flag and the primary vertical transform specification flag pt_ver_flag and specifies one transform type candidate included in the transform pair as the transform type for horizontal one-dimensional orthogonal transform (or horizontal inverse one-dimensional orthogonal transform) (trTypeH) and specifies the other candidate as the transform type for vertical one-dimensional orthogonal transform (or vertical inverse one-dimensional orthogonal transform) (trTypeV). The transform type setting unit 104 outputs the transform types (trTypeH and trTypeV) derived (set) in this way to the outside of the transform type derivation device 100.

By doing so, the transform type setting unit 104 can set an adaptive transform type from among the transform types (for example, DCT4, DST2, DST4, and the like) having a frequency characteristic capable of collecting high-frequency components in a lower order in the case where the current block has a small block size (the case of including more high-frequency components) than the case where the current block has a large block size (the case of including more low-frequency components) as candidates.

By doing so, the transform type setting unit 104 can set an adaptive transform type from among the transform types (for example, DCT8, DST1, DST7, and the like) having a frequency characteristic capable of collecting low-frequency components in a lower order in the case where the current block has a large block size (the case of including more low-frequency components) than the case where the current block has a small block size (the case of including more high-frequency components) as candidates.

That is, the transform type derivation device 100 can derive the transform type having a frequency characteristic suitable for the block size of the current block (a characteristic of (distribution of) the frequency components of the data to be orthogonally transformed or inversely orthogonally transformed). Therefore, the transform type derivation device 100 can suppress the reduction in the coding efficiency (due to the frequency characteristic of the transform type to be used being not suitable for the characteristic of the frequency component of the data to be orthogonally transformed or inversely orthogonally transformed) in the encoding and decoding to which the orthogonal transform and inverse orthogonal transform using the transform type are applied. In other words, the transform type derivation device 100 can improve the coding efficiency as compared with the case of the method of selecting the transform type without considering the frequency characteristics of the candidate transform types as described in Non-Patent Documents 1 and 2.

Furthermore, in this case, the transform type derivation device 100 can easily perform the above control (selection of the transform type candidate table) on the basis of the block size. That is, the transform type derivation device 100 can more easily improve the coding efficiency.

### Flow of Transform Type Setting Processing (Method #1)

An example of a flow of transform type setting processing executed by the transform type derivation device 100 in this case will be described with reference to the flowchart in FIG. 4.

When the transform type setting processing is started, the Emt control unit 101 of the transform type derivation device 100 determines whether or not the value of the transform flag Emtflag is true (for example, 1) in step S101. In the case where the value of the transform flag Emtflag is determined to be true, the processing proceeds to step S102.

In step S102, the transform set identifier setting unit 102 sets the transform set identifier trSetIdx on the basis of the mode information, the block size, and the color identifier.

In step S103, the transform type candidate table selection unit 103 selects the transform type candidate table as in the following expression (6), for example, on the basis of the block size of the current block. In the expression (6), tableTrSetToTrType represents the selected transform type candidate table, curBlockSize represents the block size of the current block, TH represents the threshold of the block size, tableTrSetToTrTypeA represents the transform type candidate table A111, and tableTrSetToTrTypeB represents the transform type candidate table B112.

[Math. 4]

tableTrSetToTrType=curBlockSize<TH?tableTrSetToTypeA tableTrSetToTypeB (6)

In step S104, the transform type setting unit 104 selects a transform pair specified by the transform set identifier trSetIdx and the transform index EmtIdx set in step S102 from the transform type candidate table selected in step S103. Furthermore, the transform type setting unit 104 selects a transform type trTypeH for horizontal one-dimensional orthogonal transform (or horizontal inverse one-dimensional orthogonal transform) and a transform type trTypeV for vertical one-dimensional orthogonal transform (or vertical inverse one-dimensional orthogonal transform) from the selected transform pair, using the primary horizontal transform specification flag pt_hor_flag and the primary vertical transform specification flag pt_ver_flag. That is, trTypeH and trTypeV are derived by the following expression (7), for example.

[Math. 5]

trTypeV=tableTrSetToTrType[trSetIdx][EmtIdx][0]

trTipeH=tableTrSetToTrDTpe[trSetd][EntIdxj][1] (7)

When the processing in step S104 is completed, the transform type setting processing is completed.

Furthermore, in step S101, in the case where the value of the transform flag Emtflag is determined to be false (for example, 0), the processing proceeds to step S105.

In step S105, the transform type setting unit 104 sets a predetermined transform type DefaultTrType (for example, DCT2), for example, as in the following expression (8).

[Math. 6]

trTypeH=DefaultTrType

trTypeV=DefaulTrType (8)

When the processing in step S105 is completed, the transform type setting processing is completed. By executing each processing as described above, the coding efficiency can be improved.

### Modifications

Note that, in FIG. 2, the above description has been made using an example that the transform type candidate table selection unit 103 stores the two transform type candidate tables and selects the transform type candidate table to be used from the two candidates. However, the number of transform type candidate table candidates is arbitrary. That is, the transform type candidate table selection unit 103 may store an arbitrary number of transform type candidate tables as candidates and select the transform type candidate table to be used from among the candidates. For example, the transform type candidate table selection unit 103 can prepare thresholds according to the number of candidates and classify the block size of the current block according to the threshold, and select the candidate corresponding to the block size. For example, in a case where the number of candidates is three, two thresholds are simply prepared.

Furthermore, the number of types of the transform types as elements of the transform type candidate table is arbitrary. A in FIG. 3 illustrates an example of the transform type candidate table A111 having four types of transform types (DCT2, DST4, DCT4, and DST2) as elements. However, the number of types is not limited to the example. For example, the transform type candidate table A111 may have three transform types (DCT2, DST4, and DCT4) excluding DST2 as elements or may have two transform types (DCT2 and DST4) excluding DST2 and DCT4 as elements.

Similarly, B in FIG. 3 illustrates an example of the transform type candidate table B112 having four types of transform types (DCT2, DST7, DCT8, and DST1) as elements. However, the number of types is not limited to the example. For example, the transform type candidate table B112 may have three transform types (DCT2, DST7, and DCT8) excluding DST1 as elements or may have two transform types (DCT2 and DST7) excluding DST1 and DCT8 as elements.

Furthermore, the transform type DCT8 may be replaced with FlipDST7. Moreover, the transform type DST4 may be replaced with FlipDCT4.

Note that the method of deriving the block size curBlockSize of the current block illustrated in the expression (6) is arbitrary. For example, the block size curBlockSize may be derived as in the following expression (9). In the expression (9), Width represents the block size (horizontal width) in the horizontal direction, and Height represents the block size (vertical width) in the vertical direction. Furthermore, min (A, B) is a function for selecting a smaller one between A and B. That is, in the case of the expression (9), one of the horizontal width or the vertical width of the current block, which is smaller than the other (that is, the size of the shorter width), is adopted as the block size.

[Math. 7]

curBlockSize=min(Width,Height) (9)

Furthermore, the block size curBlockSize of the current block may be derived using a logarithmic expression as in the following expression (10) instead of the expression (9).

[Math. 8]

curBlockSize=min(Log_(Width),Log₂(Height)) (10)

Note that the above description has been made using an example of selecting the transform type candidate tables in the horizontal direction and the vertical direction using the common block size (for example, the size of the shorter side). However, the embodiment is not limited to the example. For example, as in the following expression (11), the transform type candidate tables may be selected independently of each other on the basis of the block sizes of the respective directions in the vertical direction and the horizontal direction of the current block.

[Math. 9]

trTypeV=height<TH?tableTrSetToTrTypeA[trSetIdx][EmtIdx][0]: tableTrSetToTrTypeB[trSetIdx][EmtIdx][0]trTypeH=width<TH?tableTrSetToTrTypeA[trSetIdx][EmtIdx][1]: tableTrSetToTrTypeB[trSetIdx][EmtIdx][1] (11)

In this case, since the transform type can be derived from the transform type candidate table suitable for each direction, the coding efficiency can be further improved.

Furthermore, the above description has been made using an example of using the primary horizontal transform specification flag pt_hor_flag and the primary vertical transform specification flag pt_ver_flag for selecting the transform type. However, the primary horizontal transform specification flag pt_hor_flag and the primary vertical transform specification flag pt_ver_flag may be included in the transform index EmtIdx. For example, as in the following expression (12), a lower bit (0x01) of the transform index EmtIdx may be used for the primary horizontal transform specification flag pt_hor_flag, and an upper bit (0x10) of the transform index EmtIdx may be used for the primary vertical transform specification flag pt_ver_flag.

[Math. 10]

pt_ver_flag=EmtIdx &0x10

pt_hor_flag=EmtMv &0x01 (12)

An example of a flow of the transform type setting processing in that case will be described with reference to the flowchart in FIG. 5. In this case, processing in steps S111 to S113 is also executed similarly to the processing in steps S101 to S103 in FIG. 4. When the processing in step S113 is completed, the processing proceeds to step S114.

In step S114, the transform type setting unit 104 selects the transform type specified by the transform set identifier trSetIdx set in step S102 and the upper bit of the transform index EmtIdx from the transform type candidate table selected in step S113 as the vertical transform type trTypeV. Furthermore, the transform type setting unit 104 selects the transform type specified by the transform set identifier trSetIdx set in step S102 and the lower bit of the transform index EmtIdx from the transform type candidate table selected in step S113 as the vertical transform type trTypeV. That is, trTypeH and trTypeV are derived by the following expression (13), for example.

[Math. 11]

trTypeV=tableTrSetToTrType[EmdIdx&0x10]

trTypeH=tableTrSetToTrType[EmtIdx &0x01] (13)

When the processing in step S114 is completed, the transform type setting processing is completed. Furthermore, in step S111, in the case where the value of the transform flag Emtflag is determined to be false (for example, 0), the processing proceeds to step S115.

Processing in step S115 is executed similarly to the processing in step S105 (FIG. 4). When the processing in step S115 is completed, the transform type setting processing is completed. By executing each processing as described above, the coding efficiency can be improved, similarly to the case in FIG. 4.

Note that the specification of the transform type candidate table is arbitrary and is not limited to the example illustrated in the example in FIG. 3. For example, as in FIG. 6, the transform type may be selected using the transform set identifier trSetIdx and the primary vertical transform specification flag pt_ver_flag or the primary horizontal transform specification flag pt_hor_flag. A in FIG. 6 illustrates an example of the transform type candidate table A111 and B in FIG. 6 illustrates an example of the transform type candidate table B112.

### 5. SECOND EMBODIMENT

### Transform Type Derivation Device (Method #2 (Encoding Side))

Next, a method #2 will be described. FIG. 7 illustrates a main configuration example of a transform type derivation device 100 in a case of deriving a transform type to be used for primary transform and inverse primary transform by the above-described method #2. The transform type derivation device 100 in this case is a device that derives the transform type to be used in adaptive orthogonal transform on an encoding side, and selects a transform type candidate table on the basis of an RD cost.

As illustrated in FIG. 7, the transform type derivation device 100 in this case includes an RD cost calculation unit 121 and a transform type candidate table switching flag setting unit 122 in addition to the configuration in FIG. 2. In this case, an Emt control unit 101 controls the RD cost calculation unit 121 and the transform type candidate table switching flag setting unit 122 in addition to a transform set identifier setting unit 102 to a transform type setting unit 104 (dotted line arrows), and adaptively changes or does not change the transform type of the orthogonal transform.

The RD cost calculation unit 121 has an arbitrary configuration such as a CPU, ROM, and RAM, for example, and performs processing regarding derivation (calculation) of the RD cost. For example, the RD cost calculation unit 121 acquires all of transform type candidate tables from the transform type candidate table selection unit 103 and derives (calculates) the RD cost in a case of selecting each transform type. The RD cost calculation unit 121 supplies the RD cost corresponding to each calculated transform type to the transform type candidate table selection unit 103.

The transform type candidate table selection unit 103 selects the transform type candidate table on the basis of the RD cost calculated by the RD cost calculation unit 121. For example, the transform type candidate table selection unit 103 selects the transform type candidate table that minimizes the RD cost. The transform type candidate table selection unit 103 supplies the selected transform type candidate table to the transform type setting unit 104 and the transform type candidate table switching flag setting unit 122.

The transform type candidate table switching flag setting unit 122 has an arbitrary configuration such as a CPU, ROM, and RAM, for example, and performs processing regarding setting of a transform type candidate table switching flag useAltTrCandFlag. The transform type candidate table switching flag useAltTrCandFlag is information indicating, by its value, the transform type candidate table selected by the transform type candidate table selection unit 103. For example, the case where the transform type candidate table switching flag useAltTrCandFlag is 0 indicates that a transform type candidate table A111 has been selected, and the case where the transform type candidate table switching flag useAltTrCandFlag is 1 indicates that a transform type candidate table B112 has been selected. The transform type candidate table switching flag setting unit 122 outputs the set transform type candidate table switching flag useAltTrCandFlag to an outside of the transform type derivation device 100. The transform type candidate table switching flag useAltTrCandFlag is provided to a decoding side.

By doing so, the transform type derivation device 100 can derive the transform type using the transform type candidate table having the transform type with a small RD cost as an element. That is, the transform type derivation device 100 can derive a transform type with a low RD cost. Therefore, the transform type derivation device 100 can suppress reduction in coding efficiency (due to a frequency characteristic of the transform type to be used being not suitable for a characteristic of a frequency component of data to be orthogonally transformed) in encoding to which orthogonal transform using the transform type is applied. In other words, the transform type derivation device 100 can improve the coding efficiency as compared with the case of the method of selecting the transform type without considering the frequency characteristics of the candidate transform types as described in Non-Patent Documents 1 and 2.

Furthermore, as described above, the transform type derivation device 100 sets the transform type candidate table switching flag useAltTrCandFlag and provides the set flag to the decoding side, and thus becomes able to explicitly control selection of the transform type on the encoding side.

### Flow of Transform Type Setting Processing (Method #2 (Encoding Side))

An example of a flow of transform type setting processing executed by the transform type derivation device 100 in this case will be described with reference to the flowchart in FIG. 8.

When the transform type setting processing is started, the Emt control unit 101 of the transform type derivation device 100 determines whether or not a value of a transform flag Emtflag is true (for example, 1) in step S121. In the case where the value of the transform flag Emtflag is determined to be true, the processing proceeds to step S122.

In step S122, the RD cost calculation unit 121 calculates the RD cost in the case of setting each transform type candidate table (that is, for each transform type).

In step S123, the transform set identifier setting unit 102 sets a transform set identifier trSetIdx on the basis of mode information, a block size, and a color identifier.

In step S124, the transform type candidate table selection unit 103 selects the transform type candidate table on the basis of the RD cost calculated in step S122.

In step S125, the transform type setting unit 104 selects a transform pair specified by the transform set identifier trSetIdx and a transform index EmtIdx set in step S123 from the transform type candidate table selected in step S124. Furthermore, the transform type setting unit 104 selects a transform type trTypeH for horizontal one-dimensional orthogonal transform (or horizontal inverse one-dimensional orthogonal transform) and a transform type trTypeV for vertical one-dimensional orthogonal transform (or vertical inverse one-dimensional orthogonal transform) from the selected transform pair, using the primary horizontal transform specification flag pt_hor_flag and the primary vertical transform specification flag pt_ver_flag. That is, trTypeH and trTypeV are derived by the above-described expression (7), for example.

In step S126, the transform type candidate table switching flag setting unit 122 sets the transform type candidate table switching flag useAltTrCandFlag of the value indicating the transform type candidate table selected in step S124.

In step S127, the transform type candidate table switching flag setting unit 122 transmits the transform type candidate table switching flag useAltTrCandFlag set in step S126 to the decoding side.

When the processing in step S127 is completed, the transform type setting processing is completed. Furthermore, in step S121, in the case where the value of the transform flag Emtflag is determined to be false (for example, 0), the processing proceeds to step S128.

In step S128, the transform type setting unit 104 sets a predetermined transform type DefaultTrType (for example, DCT2), for example, as in the above expression (8).

When the processing in step S128 is completed, the transform type setting processing is completed. By executing each processing as described above, the coding efficiency can be improved.

### Transform Type Derivation Device (Method #2 (Decoding Side))

FIG. 9 illustrates a main configuration example of the transform type derivation device 100 in the case of deriving the transform type to be used for primary transform and inverse primary transform by the above-described method #2. The transform type derivation device 100 in this case is a device that derives the transform type to be used in adaptive orthogonal transform on the decoding side, and selects the transform type candidate table on the basis of the transform type candidate table switching flag useAltTrCandFlag provided from the encoding side. The transform type candidate table switching flag useAltTrCandFlag is identification information for identifying the transform type candidate table selected in the encoding.

As illustrated in FIG. 9, the transform type derivation device 100 in this case has a configuration similar to the case in FIG. 2.

However, in this case, the transform type candidate table selection unit 103 acquires the transform type candidate table switching flag useAltTrCandFlag input from the outside of the transform type derivation device 100 and selects the transform type candidate table (the transform type candidate table A111 or the transform type candidate table B112) on the basis of the transform type candidate table switching flag useAltTrCandFlag. The transform type candidate table selection unit 103 supplies the selected transform type candidate table to the transform type setting unit 104.

By doing so, the transform type candidate table selection unit 103 can select the same transform type candidate table as the transform type candidate table selected in the encoding (the transform type candidate table selected by the transform type candidate table selection unit 103 in FIG. 7).

Therefore, the transform type derivation device 100 can select the same transform type as the transform type selected in the encoding (the transform type selected by the transform type derivation device 100 in FIG. 7). That is, the transform type derivation device 100 can derive a transform type with a low RD cost. Therefore, the transform type derivation device 100 can suppress the reduction in the coding efficiency (due to the frequency characteristic of the transform type to be used being not suitable for the characteristic of the frequency component of the data to be inversely orthogonally transformed) in the decoding to which the inverse orthogonal transform using the transform type is applied. In other words, the transform type derivation device 100 can improve the coding efficiency as compared with the case of the method of selecting the transform type without considering the frequency characteristics of the candidate transform types as described in Non-Patent Documents 1 and 2.

Furthermore, as described above, the transform type derivation device 100 in this case simply selects the transform type candidate table on the basis of the transform type candidate table switching flag useAltTrCandFlag, thereby more easily selecting the transform type candidate table.

### Flow of Transform Type Setting Processing (Method #2 (Decoding Side))

An example of a flow of the transform type setting processing executed by the transform type derivation device 100 in this case will be described with reference to the flowchart in FIG. 10.

When the transform type setting processing is started, the transform type candidate table selection unit 103 of the transform type derivation device 100 acquires the transform type candidate table switching flag useAltTrCandFlag in step S141.

In step S142, the Emt control unit 101 determines whether or not the value of the transform flag Emtflag is true (for example, 1). In the case where the value of the transform flag Emtflag is determined to be true, the processing proceeds to step S143.

In step S143, the transform set identifier setting unit 102 sets the transform set identifier trSetIdx on the basis of the mode information, the block size, and the color identifier.

In step S144, the transform type candidate table selection unit 103 selects the transform type candidate table on the basis of the transform type candidate table switching flag useAltTrCandFlag acquired in step S141 (selects the transform type candidate table indicated by the value of the transform type candidate table switching flag useAltTrCandFlag).

In step S145, the transform type setting unit 104 selects a transform pair specified by the transform set identifier trSetIdx and the transform index EmtIdx set in step S143 from the transform type candidate table selected in step S144. Furthermore, the transform type setting unit 104 selects a transform type trTypeH for horizontal one-dimensional orthogonal transform (or horizontal inverse one-dimensional orthogonal transform) and a transform type trTypeV for vertical one-dimensional orthogonal transform (or vertical inverse one-dimensional orthogonal transform) from the selected transform pair, using the primary horizontal transform specification flag pt_hor_flag and the primary vertical transform specification flag pt_ver_flag. That is, trTypeH and trTypeV are derived by the above-described expression (7), for example.

When the processing in step S145 is completed, the transform type setting processing is completed. Furthermore, in step S142, in the case where the value of the transform flag Emtflag is determined to be false (for example, 0), the processing proceeds to step S146.

In step S146, the transform type setting unit 104 sets a predetermined transform type DefaultTrType (for example, DCT2), for example, as in the above expression (8).

When the processing in step S146 is completed, the transform type setting processing is completed. By executing each processing as described above, the coding efficiency can be improved.

Note that the various modifications described in <Modifications> of <4. First Embodiment> can be similarly applied to the case of the present embodiment.

### 6. THIRD EMBODIMENT

### Transform Type Derivation Device (Method #3)

Next, a method #3 will be described. FIG. 11 illustrates a main configuration example of a transform type derivation device 100 in a case of deriving a transform type to be used for primary transform and inverse primary transform by the above-described method #3. The transform type derivation device 100 in this case selects a transform type candidate table on the basis of an inter prediction mode (for example, whether prediction is mono-prediction or bi-prediction).

As illustrated in FIG. 11, the transform type derivation device 100 in this case has a configuration similar to the case in FIG. 2.

However, in this case, a transform type candidate table selection unit 103 acquires information indicating the inter prediction mode input from an outside of the transform type derivation device 100, and selects a transform type candidate table (a transform type candidate table A111 or a transform type candidate table B112) on the basis of the inter prediction mode (for example, the mono-prediction or the bi-prediction). The transform type candidate table selection unit 103 supplies the selected transform type candidate table to a transform type setting unit 104.

By doing so, the transform type setting unit 104 can set an adaptive transform type from among transform types (for example, DCT4, DST2, DST4, and the like) having a frequency characteristic capable of collecting high-frequency components in a lower order in the case of mono-prediction (the case of including more high-frequency components) than the case of bi-prediction (the case of including more low-frequency components) as candidates, for example.

In other words, the transform type setting unit 104 can set an adaptive transform type from among the transform types (for example, DCT8, DST1, DST7, and the like) having a frequency characteristic capable of collecting low-frequency components in a lower order in the case of bi-prediction (the case of including more low-frequency components) than the case of mono-prediction (the case of including more high-frequency components) as candidates.

That is, the transform type derivation device 100 can derive the transform type having a frequency characteristic suitable for the inter prediction mode (a characteristic of (distribution of) frequency components of data to be orthogonally transformed or inversely orthogonally transformed). Therefore, the transform type derivation device 100 can suppress the reduction in the coding efficiency (due to the frequency characteristic of the transform type to be used being not suitable for the characteristic of the frequency component of the data to be orthogonally transformed or inversely orthogonally transformed) in the encoding and decoding to which the orthogonal transform and inverse orthogonal transform using the transform type are applied. In other words, the transform type derivation device 100 can improve the coding efficiency as compared with the case of the method of selecting the transform type without considering the frequency characteristics of the candidate transform types as described in Non-Patent Documents 1 and 2.

Furthermore, in this case, the transform type derivation device 100 can easily perform the above control (selection of the transform type candidate table) on the basis of the inter prediction mode. That is, the transform type derivation device 100 can more easily improve the coding efficiency.

### Flow of Transform Type Setting Processing (Method #3)

An example of a flow of transform type setting processing executed by the transform type derivation device 100 in this case will be described with reference to the flowchart in FIG. 12.

Processing in steps S161 and S162 in FIG. 12 is executed similarly to the processing in steps S101 and S102 in FIG. 4.

In step S163, the transform type candidate table selection unit 103 selects the transform type candidate table on the basis of the inter prediction mode.

Processing in steps S164 and S165 is executed similarly to the processing in steps S104 and S105 in FIG. 4.

When the processing in step S164 or S165 is completed, the transform type setting processing is completed. By executing each processing as described above, the coding efficiency can be improved.

Note that the various modifications described in <Modifications> of <4. First Embodiment> can be similarly applied to the case of the present embodiment.

### 7. FOURTH EMBODIMENT

### Transform Type Derivation Device (Method #4)

Next, a method #4 will be described. FIG. 13 illustrates a main configuration example of a transform type derivation device 100 in a case of deriving a transform type to be used for primary transform and inverse primary transform by the above-described method #4. The transform type derivation device 100 in this case selects a transform type candidate table on the basis of pixel accuracy of a motion vector (for example, whether the motion vector indicates an integer position or a subpel position).

As illustrated in FIG. 13, the transform type derivation device 100 in this case has a configuration similar to the case in FIG. 2.

However, in this case, a transform type candidate table selection unit 103 acquires information indicating the pixel accuracy of the motion vector input from an outside of the transform type derivation device 100, and selects a transform type candidate table (a transform type candidate table A111 or a transform type candidate table B112) on the basis of the pixel accuracy of the motion vector (for example, whether the position pointed to by the motion vector is the integer position or the subpel position). The transform type candidate table selection unit 103 supplies the selected transform type candidate table to a transform type setting unit 104.

By doing so, the transform type setting unit 104 can set an adaptive transform type from among transform types (for example, DCT4, DST2, DST4, and the like) having a frequency characteristic capable of collecting high-frequency components in a lower order in the case where the position pointed to by the motion vector is the integer position (the case of including more high-frequency components) than the case where the position pointed to by the motion vector is the subpel position (the case of including more low-frequency components) as candidates, for example.

In other words, the transform type setting unit 104 can set an adaptive transform type from among the transform types (for example, DCT8, DST1, DST7, and the like) having a frequency characteristic capable of collecting low-frequency components in a lower order in the case where the position pointed to by the motion vector is the subpel position (the case of including more low-frequency components) than the case where the position pointed to by the motion vector is the integer position (the case of including more high-frequency components) as candidates.

That is, the transform type derivation device 100 can derive the transform type having a frequency characteristic suitable for the pixel accuracy of the motion vector (a characteristic of (distribution of) the frequency components of the data to be orthogonally transformed or inversely orthogonally transformed). Therefore, the transform type derivation device 100 can suppress the reduction in the coding efficiency (due to the frequency characteristic of the transform type to be used being not suitable for the characteristic of the frequency component of the data to be orthogonally transformed or inversely orthogonally transformed) in the encoding and decoding to which the orthogonal transform and inverse orthogonal transform using the transform type are applied. In other words, the transform type derivation device 100 can improve the coding efficiency as compared with the case of the method of selecting the transform type without considering the frequency characteristics of the candidate transform types as described in Non-Patent Documents 1 and 2.

Furthermore, in this case, the transform type derivation device 100 can easily perform the above control (selection of the transform type candidate table) on the basis of the pixel accuracy of the motion vector. That is, the transform type derivation device 100 can more easily improve the coding efficiency.

### Flow of Transform Type Setting Processing (Method #4)

An example of a flow of transform type setting processing executed by the transform type derivation device 100 in this case will be described with reference to the flowchart in FIG. 14.

Processing in steps S171 and S172 in FIG. 14 is executed similarly to the processing in steps S101 and S102 in FIG. 4.

In step S173, the transform type candidate table selection unit 103 selects the transform type candidate table on the basis of the pixel accuracy of the motion vector.

Processing in steps S174 and S175 is executed similarly to the processing in steps S104 and S105 in FIG. 4.

When the processing in step S174 or S175 is completed, the transform type setting processing is completed. By executing each processing as described above, the coding efficiency can be improved.

Note that the various modifications described in <Modifications> of <4. First Embodiment> can be similarly applied to the case of the present embodiment.

### 8. FIFTH EMBODIMENT

### Image Encoding Device

Note that the present technology can be applied to an arbitrary configuration (an apparatus, a device, a system, or the like) and is not limited to the above-described example of the transform type derivation device 100. For example, the present technology can be applied to an image encoding device that encodes an image using orthogonal transform or inverse orthogonal transform. In the present embodiment, a case where the present technology is applied to such an image encoding device will be described.

FIG. 15 is a block diagram illustrating an example of a configuration of an image encoding device that is one mode of an image processing apparatus to which the present technology is applied. An image encoding device 200 illustrated in FIG. 15 is a device that encodes image data of a moving image. For example, the image encoding device 200 implements the technology described in Non-Patent Documents 1 to 4 and encodes the image data of the moving image by a method conforming to the standard described in any of the aforementioned documents.

Note that FIG. 15 illustrates main processing units, data flows, and the like, and those illustrated in FIG. 15 are not necessarily everything. That is, in the image encoding device 200, there may be a processing unit not illustrated as a block in FIG. 15, or processing or data flow not illustrated as an arrow or the like in FIG. 15. This is similar in other drawings for describing a processing unit and the like in the image encoding device 200.

As illustrated in FIG. 15, the image encoding device 200 includes a control unit 201, a rearrangement buffer 211, a calculation unit 212, an orthogonal transform unit 213, a quantization unit 214, an encoding unit 215, an accumulation buffer 216, an inverse quantization unit 217, an inverse orthogonal transform unit 218, a calculation unit 219, an in-loop filter unit 220, a frame memory 221, a prediction unit 222, and a rate control unit 223.

### Control Unit

The control unit 201 divides moving image data held by the rearrangement buffer 211 into blocks (CUs, PUs, transform blocks, or the like) in units of processing on the basis of a block size in external or pre-designated units of processing. Furthermore, the control unit 201 determines encoding parameters (header information Hinfo, prediction mode information Pinfo, transform information Tinfo, filter information Finfo, and the like) to be supplied to each block on the basis of, for example, rate-distortion optimization (RDO).

Details of these encoding parameters will be described below. After determining the above-described encoding parameters, the control unit 201 supplies the encoding parameters to each block. Specifically, the encoding parameters are as follows.

The header information Hinfo is supplied to each block. The prediction mode information Pinfo is supplied to the encoding unit 215 and the prediction unit 222. The transform information Tinfo is supplied to the encoding unit 215, the orthogonal transform unit 213, the quantization unit 214, the inverse quantization unit 217, and the inverse orthogonal transform unit 218. The filter information Finfo is supplied to the in-loop filter unit 220.

### Control of Orthogonal Transform/Inverse Orthogonal Transform

Note that, the control unit 201 sets or derives information regarding control of orthogonal transform by the orthogonal transform unit 213 and inverse orthogonal transform by the inverse orthogonal transform unit 218. The control unit 201 supplies the information obtained in this way to the orthogonal transform unit 213 and the inverse orthogonal transform unit 218, thereby controlling the orthogonal transform performed by the orthogonal transform unit 213 and the inverse orthogonal transformed performed by the inverse orthogonal transform unit 218.

### Rearrangement Buffer

Each field (input image) of moving image data is input to the image encoding device 200 in reproduction order (display order). The rearrangement buffer 211 acquires and holds (stores) each input image in its reproduction order (display order). The rearrangement buffer 211 rearranges the input images in encoding order (decoding order) or divides the input images into blocks in units of processing on the basis of the control of the control unit 201. The rearrangement buffer 211 supplies the processed input image to the calculation unit 212. Furthermore, the rearrangement buffer 211 also supplies the input images (original images) to the prediction unit 222 and the in-loop filter unit 220.

### Calculation Unit

The calculation unit 212 receives an image I corresponding to the block in units of processing and a predicted image P supplied from the prediction unit 222 as inputs, subtracts the predicted image P from the image I as illustrated in the following expression (14) to derive a prediction residual D, and supplies the prediction residual D to the orthogonal transform unit 213.

[Math. 12]

D=I−P (14)

### Orthogonal Transform Unit

The orthogonal transform unit 213 receives the prediction residual D supplied from the calculation unit 212 and the transform information Tinfo supplied from the control unit 201 as inputs, and orthogonally transforms the prediction residual D on the basis of the transform information Tinfo to derive a transform coefficient Coeff. Note that the orthogonal transform unit 213 can perform adaptive orthogonal transform (AMT) for adaptively selecting the type (transform coefficient) of the orthogonal transform. The orthogonal transform unit 213 supplies the obtained transform coefficient Coeff to the quantization unit 214.

### Quantization Unit

The quantization unit 214 receives the transform coefficient Coeff supplied from the orthogonal transform unit 213 and the transform information Tinfo supplied from the control unit 201 as inputs, and scales (quantizes) the transform coefficient Coeff on the basis of the transform information Tinfo. Note that a rate of this quantization is controlled by the rate control unit 223. The quantization unit 214 supplies a quantized transform coefficient obtained by the quantization, that is, a quantized transform coefficient level level to the encoding unit 215 and the inverse quantization unit 217.

### Encoding Unit

The encoding unit 215 receives, as inputs, the quantized transform coefficient level level supplied from the quantization unit 214, the various encoding parameters (header information Hinfo, prediction mode information Pinfo, transform information Tinfo, filter information Finfo, and the like) supplied from the control unit 201, information regarding a filter such as a filter coefficient supplied from the in-loop filter unit 220, and information regarding an optimal prediction mode supplied from the prediction unit 222. The encoding unit 215 performs variable-length coding (for example, arithmetic coding) for the quantized transform coefficient level level to generate a bit string (coded data).

Furthermore, the encoding unit 215 derives residual information Rinfo from the quantized transform coefficient level level, and encodes the residual information Rinfo to generate a bit string.

Moreover, the encoding unit 215 includes the information regarding a filter supplied from the in-loop filter unit 220 to the filter information Finfo, and includes the information regarding an optimal prediction mode supplied from the prediction unit 222 to the prediction mode information Pinfo. Then, the encoding unit 215 encodes the above-described various encoding parameters (header information Hinfo, prediction mode information Pinfo, transform information Tinfo, filter information Finfo, and the like) to generate a bit string.

Furthermore, the encoding unit 215 multiplexes the bit string of the various types of information generated as described above to generate coded data. The encoding unit 215 supplies the coded data to the accumulation buffer 216.

### Accumulation Buffer

The accumulation buffer 216 temporarily stores the coded data obtained by the encoding unit 215. The accumulation buffer 216 outputs the stored coded data to an outside of the image encoding device 200 as a bitstream or the like at predetermined timing. For example, the coded data is transmitted to a decoding side via an arbitrary recording medium, an arbitrary transmission medium, an arbitrary information processing device, or the like. That is, the accumulation buffer 216 is also a transmission unit that transmits coded data (bitstream).

### Inverse Quantization Unit

The inverse quantization unit 217 performs processing regarding inverse quantization. For example, the inverse quantization unit 217 receives the quantized transform coefficient level level supplied from the quantization unit 214 and the transform information Tinfo supplied from the control unit 201 as inputs, and scales (inversely quantizes) the value of the quantized transform coefficient level level on the basis of the transform information Tinfo. Note that the inverse quantization is inverse processing of the quantization performed in the quantization unit 214. The inverse quantization unit 217 supplies a transform coefficient Coeff_IQ obtained by the inverse quantization to the inverse orthogonal transform unit 218.

### Inverse Orthogonal Transform Unit

The inverse orthogonal transform unit 218 performs processing regarding inverse orthogonal transform. For example, the inverse orthogonal transform unit 218 receives the transform coefficient Coeff_IQ supplied from the inverse quantization unit 217 and the transform information Tinfo supplied from the control unit 201 as inputs, and inversely orthogonally transforms the transform coefficient Coeff_IQ on the basis of the transform information Tinfo to derive a prediction residual D′. Note that the inverse orthogonal transform is inverse processing of the orthogonal transform performed in the orthogonal transform unit 213. That is, the inverse orthogonal transform unit 218 can perform adaptive inverse orthogonal transform (AMT) for adaptively selecting the type (transform coefficient) of the inverse orthogonal transform.

The inverse orthogonal transform unit 218 supplies the prediction residual D′ obtained by the inverse orthogonal transform to the calculation unit 219. Note that, since the inverse orthogonal transform unit 218 is similar to an inverse orthogonal transform unit on the decoding side (to be described below), description (to be described below) to be given for the decoding side can be applied to the inverse orthogonal transform unit 218.

### Calculation Unit

The calculation unit 219 receives the prediction residual D′ supplied from the inverse orthogonal transform unit 218 and the predicted image P supplied from the prediction unit 222 as inputs. The calculation unit 219 adds the prediction residual D′ and the predicted image P corresponding to the prediction residual D′ to derive a locally decoded image Rlocal. The calculation unit 219 supplies the derived locally decoded image Rlocal to the in-loop filter unit 220 and the frame memory 221.

### In-Loop Filter Unit

The in-loop filter unit 220 performs processing regarding in-loop filter processing. For example, the in-loop filter unit 220 receives the locally decoded image Rlocal supplied from the calculation unit 219, the filter information Finfo supplied from the control unit 201, and the input image (original image) supplied from the rearrangement buffer 211 as inputs. Note that the information input to the in-loop filter unit 220 may be information other than the aforementioned information. For example, information such as the prediction mode, motion information, a code amount target value, a quantization parameter QP, a picture type, a block (a CU, a CTU, or the like) may be input to the in-loop filter unit 220, as necessary.

The in-loop filter unit 220 appropriately performs filtering processing for the locally decoded image Rlocal on the basis of the filter information Finfo. The in-loop filter unit 220 also uses the input image (original image) and other input information for the filtering processing as necessary.

For example, the in-loop filter unit 220 applies four in-loop filters of a bilateral filter, a deblocking filter (DBF), an adaptive offset filter (sample adaptive offset (SAO)), and an adaptive loop filter (adaptive loop filter (ALF)) in this order, as described in Non-Patent Document 1. Note that which filter is applied and in which order the filters are applied are arbitrary and can be selected as appropriate.

Of course, the filtering processing performed by the in-loop filter unit 220 is arbitrary, and is not limited to the above example. For example, the in-loop filter unit 220 may apply a Wiener filter or the like.

The in-loop filter unit 220 supplies the filtered locally decoded image Rlocal to the frame memory 221. Note that, for example, in a case of transmitting the information regarding filters such as filter coefficients to the decoding side, the in-loop filter unit 220 supplies the information regarding filters to the encoding unit 215.

### Frame Memory

The frame memory 221 performs processing regarding storage of data relating to an image. For example, the frame memory 221 receives the locally decoded image Rlocal supplied from the calculation unit 219 and the filtered locally decoded image Rlocal supplied from the in-loop filter unit 220 as inputs, and holds (stores) the inputs. Furthermore, the frame memory 221 reconstructs and holds a decoded image R for each picture unit, using the locally decoded image Rlocal (stores the decoded image R in a buffer in the frame memory 221). The frame memory 221 supplies the decoded image R (or a part thereof) to the prediction unit 222 in response to a request from the prediction unit 222.

### Prediction Unit

The prediction unit 222 performs processing regarding generation of a predicted image. For example, the prediction unit 222 receives, as inputs, the prediction mode information Pinfo supplied from the control unit 201, the input image (original image) supplied from the rearrangement buffer 211, and the decoded image R (or a part thereof) read from the frame memory 221. The prediction unit 222 performs prediction processing such as inter prediction, intra prediction, or the like, using the prediction mode information Pinfo and the input image (original image), performs prediction, using the decoded image R as a reference image, performs motion compensation processing on the basis of a prediction result, and generates a predicted image P. The prediction unit 222 supplies the generated predicted image P to the calculation units 212 and 219. Furthermore, the prediction unit 222 supplies a prediction mode selected by the above processing, that is, the information regarding an optimal prediction mode to the encoding unit 215, as necessary.

### Rate Control Unit

The rate control unit 223 performs processing regarding rate control. For example, the rate control unit 223 controls a rate of a quantization operation of the quantization unit 214 so that an overflow or an underflow does not occur on the basis of the code amount of the coded data accumulated in the accumulation buffer 216.

### Details of Orthogonal Transform Unit

FIG. 16 is a block diagram illustrating a main configuration example of the orthogonal transform unit 213 in FIG. 15. As illustrated in FIG. 16, the orthogonal transform unit 213 includes a primary transform unit 261 and a secondary transform unit 262.

The primary transform unit 261 is configured to perform processing regarding primary transform that is predetermined transform processing such as orthogonal transform, for example. For example, the primary transform unit 261 receives the prediction residual D and the transform information Tinfo (horizontal transform type index TrTypeH, vertical transform type index TrTypeV, and the like) as inputs.

The primary transform unit 261 performs primary transform for the prediction residual D to derive a transform coefficient Coeff_P after primary transform using a transform matrix corresponding to the horizontal transform type index TrTypeH and a transform matrix corresponding to the vertical transform type index TrTypeV. The primary transform unit 261 supplies the derived transform coefficient Coeff_P to the secondary transform unit 262.

As illustrated in FIG. 16, the primary transform unit 261 includes a primary horizontal transform unit 271 and a primary vertical transform unit 272.

The primary horizontal transform unit 271 is configured to perform processing regarding primary horizontal transform that is one-dimensional orthogonal transform in the horizontal direction. For example, the primary horizontal transform unit 271 receives the prediction residual D and the transform information Tinfo (horizontal transform type index TrTypeH and the like) as inputs. The primary horizontal transform unit 271 performs primary horizontal transform for the prediction residual D using the transform matrix corresponding to the horizontal transform type index TrTypeH. The primary horizontal transform unit 271 supplies the transform coefficient after primary horizontal transform to the primary vertical transform unit 272.

The primary vertical transform unit 272 is configured to perform processing regarding primary vertical transform that is one-dimensional orthogonal transform in the vertical direction. For example, the primary vertical transform unit 272 receives the transform coefficient after primary horizontal transform and the transform information Tinfo (vertical transform type index TrTypeV and the like) as inputs. The primary vertical transform unit 272 performs primary vertical transform for the transform coefficient after primary horizontal transform using the transform matrix corresponding to the vertical transform type index TrTypeV. The primary vertical transform unit 272 supplies the transform coefficient after primary vertical transform (that is, the transform coefficient Coeff_P after primary transform) to the secondary transform unit 262.

The secondary transform unit 262 is configured to perform processing regarding secondary transform that is predetermined transform processing such as orthogonal transform, for example. For example, the secondary transform unit 262 receives the transform coefficient Coeff_P and the transform information Tinfo as inputs. The secondary transform unit 262 performs the secondary transform for the transform coefficient Coeff_P to derive the transform coefficient Coeff after secondary transform on the basis of the transform information Tinfo. The secondary transform unit 262 outputs the transform coefficient Coeff to the outside of the orthogonal transform unit 213 (supplies the transform coefficient Coeff to the quantization unit 214).

Note that the orthogonal transform unit 213 can skip (omit) one or both of the primary transform by the primary transform unit 261 and the secondary transform by the secondary transform unit 262. Furthermore, the primary horizontal transform by the primary horizontal transform unit 271 may be skipped (omitted). Similarly, the primary vertical transform by the primary vertical transform unit 272 may be skipped (omitted).

### Primary Horizontal Transform Unit

FIG. 17 is a block diagram illustrating a main configuration example of the primary horizontal transform unit 271 in FIG. 16. As illustrated in FIG. 17, the primary horizontal transform unit 271 includes a transform matrix derivation unit 281, a matrix calculation unit 282, a scaling unit 283, and a clip unit 284.

The transform matrix derivation unit 281 has at least a configuration necessary for performing processing regarding derivation of a transform matrix T_{H} for primary horizontal transform (a transform matrix T_{H} for horizontal one-dimensional orthogonal transform). For example, the transform matrix derivation unit 281 receives the horizontal transform type index TrTypeH and information regarding a size of a transform block as inputs. The transform matrix derivation unit 281 derives the transform matrix T_{H} for primary horizontal transform corresponding to the horizontal transform type index TrTypeH and having the same size as the transform block. The transform matrix derivation unit 281 supplies the transform matrix TH to the matrix calculation unit 282.

The matrix calculation unit 282 has at least a configuration necessary for performing processing regarding matrix calculation. For example, the matrix calculation unit 282 receives the transform matrix T_{H} supplied from the transform matrix derivation unit 281 and input data Xᵢₙ (that is, the transform block of the prediction residual D) as inputs. The matrix calculation unit 282 performs the horizontal one-dimensional orthogonal transform for the input data Xᵢₙ (that is, the transform block of the prediction residual D), using the transform matrix T supplied from the transform matrix derivation unit 281, to obtain intermediate data Y1. This calculation can be expressed by a determinant as in the following expression (15).

[Math. 13]

Y1=Xᵢₙ×T_{H}^{T} (15)

The matrix calculation unit 282 supplies the intermediate data Y1 to the scaling unit 283.

The scaling unit 283 scales a coefficient Y1 [i, j] of each i-row j-column component of the intermediate data Y1 with a predetermined shift amount S_{H} to obtain intermediate data Y2. This scaling can be expressed as the following expression (16). Hereinafter, an i-row j-column component ((i, j) component) of a certain two-dimensional matrix (two-dimensional array) X is written as X [i, j].

[Math. 14]

Y2[i,j]=Y1[i,j]>>S_{H} (16)

The scaling unit 283 supplies the intermediate data Y2 to the clip unit 284.

The clip unit 284 clips a value of a coefficient Y2 [i, j] of each i-row j-column component of the intermediate data Y2, and derives output data Xₒᵤₜ (that is, the transform coefficient after primary horizontal transform). This processing can be expressed as the following expression (17).

[Math. 15]

Xₒᵤₜ[i,j]=Clip3(min coefVal,max CoefVal,Y2[i,j]) (17)

The clip unit 284 outputs the output data Xₒᵤₜ (the transform coefficient after primary horizontal transform) to the outside of the primary horizontal transform unit 271 (supplies the same to the primary vertical transform unit 272).

### Transform Matrix Derivation Unit

FIG. 18 is a block diagram illustrating a main configuration example of the transform matrix derivation unit 281 in FIG. 17. As illustrated in FIG. 18, the transform matrix derivation unit 281 includes a transform matrix LUT 291, a flip unit 292, and a transposition unit 293. Note that, in FIG. 18, arrows representing data transfer are omitted, but in the transform matrix derivation unit 281, arbitrary data can be transferred between arbitrary processing units (processing blocks).

The transform matrix LUT 291 is a lookup table for holding (storing) a transform matrix corresponding to the horizontal transform type index TrTypeH and a size N of the transform block. When the horizontal transform type index TrTypeH and the size N of the transform block are specified, the transform matrix LUT 291 selects and outputs a transform matrix corresponding thereto. In the case of this derivation example, the transform matrix LUT 291 supplies the transform matrix to both or one of the flip unit 292 and the transposition unit 293 as a base transform matrix T_{base}.

The flip unit 292 flips an input transform matrix T of N rows and N columns, and outputs a flipped transform matrix T_{flip}. In the case of this derivation example, the flip unit 292 receives the base transform matrix T_{base} of N rows and N columns supplied from the transform matrix LUT 291 as an input, flips the base transform matrix T_{base} in the row direction (horizontal direction), and outputs the flipped transform matrix T_{flip} to the outside of the transform matrix derivation unit 281 (supplies the same to the matrix calculation unit 282) as the transform matrix T_{H}.

The transposition unit 293 transposes the input transform matrix T of N rows and N columns, and outputs a transposed transform matrix Tₜᵣₐₙₛₚₒₛₑ. In the case of this derivation example, the transposition unit 293 receives the base transform matrix T_{base} of N rows and N columns supplied from the transform matrix LUT 291 as an input, transposes the base transform matrix T_{base}, and outputs the transposed transform matrix Tₜᵣₐₙₛₚₒₛₑ to the outside of the transform matrix derivation unit 281 (supplies the same to the matrix calculation unit 282) as the transform matrix T_{H}.

### Primary Vertical Transform Unit

FIG. 19 is a block diagram illustrating a main configuration example of the primary vertical transform unit 272 in FIG. 16. As illustrated in FIG. 19, the primary vertical transform unit 272 includes a transform matrix derivation unit 301, a matrix calculation unit 302, a scaling unit 303, and a clip unit 304.

The transform matrix derivation unit 301 has at least a configuration necessary for performing processing regarding derivation of a transform matrix T_{V} for primary vertical transform (a transform matrix T_{V} for vertical one-dimensional orthogonal transform). For example, the transform matrix derivation unit 301 receives the vertical transform type index TrTypeV and the information regarding the size of the transform block as inputs. The transform matrix derivation unit 301 derives the transform matrix T_{V} for primary vertical transform corresponding to the vertical transform type index TrTypeV and having the same size as the transform block. The transform matrix derivation unit 301 supplies the transform matrix T_{V} to the matrix calculation unit 302.

The matrix calculation unit 302 has at least a configuration necessary for performing processing regarding matrix calculation. For example, the matrix calculation unit 302 uses the transform matrix T_{V} supplied from the transform matrix derivation unit 301 and the input data Xᵢₙ as inputs. For example, the matrix calculation unit 302 performs the vertical one-dimensional orthogonal transform for the input data Xin (that is, the transform block of the transform coefficient after primary horizontal transform), using the transform matrix T_{V} supplied from the transform matrix derivation unit 301, to obtain intermediate data Y1. This calculation can be expressed by a determinant as in the following expression (18).

[Math. 16]

Y1=T_{V}×Xᵢₙ (18)

The matrix calculation unit 302 supplies the intermediate data Y1 to the scaling unit 303.

The scaling unit 303 scales the coefficient Y1 [i, j] of each i-row j-column component of the intermediate data Y1 with a predetermined shift amount S_{V} to obtain intermediate data Y2. This scaling can be expressed as the following expression (19).

[Math. 17]

Y2[i,j]=Y1[i,j]>>S_{V} (19)

The scaling unit 303 supplies the intermediate data Y2 to the clip unit 304.

The clip unit 304 clips the value of the coefficient Y2 [i, j] of each i-row j-column component of the intermediate data Y2, and derives output data Xₒᵤₜ (that is, the transform coefficient after primary vertical transform). This processing can be expressed as the following expression (20).

[Math. 18]

Xₒᵤₜ[i,j]=Clip3(min CoefVal,max CoefVal,Y2[i,j]) (20)

The clip unit 304 outputs the output data Xₒᵤₜ (transform coefficient after primary vertical transform) to the outside of the primary vertical transform unit 272 (supplies the same to the secondary transform unit 262) as the transform coefficient Coeff_P after primary transform.

### Transform Matrix Derivation Unit

FIG. 20 is a block diagram illustrating a main configuration example of the transform matrix derivation unit 301 in FIG. 19. As illustrated in FIG. 20, the transform matrix derivation unit 301 includes a transform matrix LUT 311, a flip unit 312, and a transposition unit 313. Note that, in FIG. 20, arrows representing data transfer are omitted, but in the transform matrix derivation unit 301, arbitrary data can be transferred between arbitrary processing units (processing blocks).

The transform matrix LUT 311 is a lookup table for holding (storing) a transform matrix corresponding to the vertical transform type index TrTypeV and the size N of the transform block. When the vertical transform type index TrTypeIdxV and the size N of the transform block are specified, the transform matrix LUT 311 selects and outputs a transform matrix corresponding thereto. In the case of this derivation example, the transform matrix LUT 311 supplies the transform matrix to both or one of the flip unit 312 and the transposition unit 313 as the base transform matrix T_{base}.

The flip unit 312 flips an input transform matrix T of N rows and N columns, and outputs a flipped transform matrix T_{flip}. In the case of this derivation example, the flip unit 312 receives the base transform matrix T_{base} of N rows and N columns supplied from the transform matrix LUT 311 as an input, flips the base transform matrix T_{base} in the row direction (horizontal direction), and outputs the flipped transform matrix T_{flip} to the outside of the transform matrix derivation unit 301 (supplies the same to the matrix calculation unit 302) as the transform matrix T_{V}.

The transposition unit 313 transposes the input transform matrix T of N rows and N columns, and outputs a transposed transform matrix Tₜᵣₐₙₛₚₒₛₑ. In the case of this derivation example, the transposition unit 313 receives the base transform matrix T_{base} of N rows and N columns supplied from the transform matrix LUT 311 as an input, transposes the base transform matrix T_{base}, and outputs the transposed transform matrix Tₜᵣₐₙₛₚₒₛₑ to the outside of the transform matrix derivation unit 301 (supplies the same to the matrix calculation unit 302) as the transform matrix T_{V}.

### Flow of Image Encoding Processing

Next, a flow of each processing executed by the image encoding device 200 having the above configuration will be described. First, an example of a flow of image encoding processing will be described with reference to the flowchart in FIG. 21.

When the image encoding processing is started, in step S201, the rearrangement buffer 211 is controlled by the control unit 201 and rearranges frames of input moving image data from the display order to the encoding order.

In step S202, the control unit 201 sets the unit of processing (performs block division) for an input image held by the rearrangement buffer 211.

In step S203, the control unit 201 determines (sets) an encoding parameter for the input image held by the rearrangement buffer 211.

In step S204, the control unit 201 performs orthogonal transform control processing and performs processing regarding control of the orthogonal transform.

In step S205, the prediction unit 222 performs prediction processing and generates a predicted image or the like in the optimal prediction mode. For example, in the prediction processing, the prediction unit 222 performs intra prediction to generate a predicted image or the like in an optimal intra prediction mode, performs inter prediction to generate a predicted image or the like in an optimal inter prediction mode, and selects an optimal prediction mode from among the predicted images on the basis of a cost function value and the like.

In step S206, the calculation unit 212 calculates a difference between the input image and the predicted image in the optimal mode selected by the prediction processing in step S205. That is, the calculation unit 212 generates the prediction residual D between the input image and the predicted image. The prediction residual D obtained in this way is reduced in the data amount as compared with the original image data. Therefore, the data amount can be compressed as compared with a case of encoding the image as it is.

In step S207, the orthogonal transform unit 213 performs orthogonal transform processing for the prediction residual D generated by the processing in step S206 according to the control performed in step S204 to derive the transform coefficient Coeff.

In step S208, the quantization unit 214 quantizes the transform coefficient Coeff obtained by the processing in step S207 by using a quantization parameter calculated by the control unit 201 or the like to derive the quantized transform coefficient level level.

In step S209, the inverse quantization unit 217 inversely quantizes the quantized transform coefficient level level generated by the processing in step S208 with characteristics corresponding to the characteristics of the quantization in step S208 to derive the transform coefficient Coeff_IQ.

In step S210, the inverse orthogonal transform unit 218 inversely orthogonally transforms the transform coefficient Coeff_IQ obtained by the processing in step S209 according to the control performed in step S204 by a method corresponding to the orthogonal transform processing in step S207 to derive the prediction residual D′. Note that, since the inverse orthogonal transform processing is similar to inverse orthogonal transform processing (to be described below) performed on the decoding side, description (to be given below) for the decoding side can be applied to the inverse orthogonal transform processing in step S210.

In step S211, the calculation unit 219 adds the predicted image obtained by the prediction processing in step S205 to the prediction residual D′ derived by the processing in step S210 to generate a locally decoded image.

In step S212, the in-loop filter unit 220 performs the in-loop filter processing for the locally decoded image derived by the processing in step S211.

In step S213, the frame memory 221 stores the locally decoded image derived by the processing in step S211 and the locally decoded image filtered in step S212.

In step S214, the encoding unit 215 encodes the quantized transform coefficient level level obtained by the processing in step S208. For example, the encoding unit 215 encodes the quantized transform coefficient level level that is information regarding the image by arithmetic coding or the like to generate the coded data. Furthermore, at this time, the encoding unit 215 encodes the various encoding parameters (header information Hinfo, prediction mode information Pinfo, and transform information Tinfo). Moreover, the encoding unit 215 derives the residual information RInfo from the quantized transform coefficient level level and encodes the residual information RInfo.

In step S215, the accumulation buffer 216 accumulates the coded data thus obtained, and outputs the coded data to the outside of the image encoding device 200, for example, as a bitstream. The bitstream is transmitted to the decoding side via a transmission path or a recording medium, for example. Furthermore, the rate control unit 223 performs rate control as necessary.

When the processing in step S215 is completed, the image encoding processing is completed.

### Flow of Orthogonal Transform Processing

Next, an example of a flow of the orthogonal transform processing executed in step S207 in FIG. 21 will be described with reference to the flowchart in FIG. 22.

When the orthogonal transform processing is started, in step S251, the orthogonal transform unit 213 determines whether a transform skip flag ts_flag is 2D_TS (in a case of two-dimensional transform skip) (for example, 1 (true)) or a transform quantization bypass flag transquant_bypass_flag is 1 (true). In a case where it is determined that the transform skip flag ts_flag is 2D_TS (for example, 1 (true)) or the transform quantization bypass flag is 1 (true), the orthogonal transform processing ends, and the processing returns to FIG. 21. In this case, the orthogonal transform processing (primary transform and secondary transform) is omitted, and the input prediction residual D is used as the transform coefficient Coeff.

Furthermore, in step S251 in FIG. 22, in a case where it is determined that the transform skip flag ts_flag is not 2D_TS (not two-dimensional transform skip) (for example, 0 (false)) and the transform quantization bypass flag transquant_bypass_flag is 0 (false), the processing proceeds to step S252. In this case, primary transform processing and secondary transform processing are performed.

In step S252, the primary transform unit 261 performs the primary transform processing for the input prediction residual D to derive the transform coefficient Coeff_P after primary transform.

In step S253, the secondary transform unit 262 performs the secondary transform processing for the transform coefficient Coeff_P to derive the transform coefficient Coeff after secondary transform.

When the processing in step S253 is completed, the orthogonal transform processing is completed.

### Flow of Primary Transform Processing

Next, an example of a flow of the primary transform processing executed in step S252 in FIG. 22 will be described with reference to the flowchart in FIG. 23.

When the primary transform processing is started, the primary horizontal transform unit 271 of the primary transform unit 261 performs primary horizontal transform processing for the prediction residual D in step S261 to derive a transform coefficient after primary horizontal transform.

In step S262, the primary vertical transform unit 272 of the primary transform unit 261 performs primary vertical transform for the primary horizontal transform result (transform coefficient after primary horizontal transform) obtained in step S261 to derive a transform coefficient after primary vertical transform (transform coefficient Coeff_P after primary transform).

When the processing in step S262 ends, the primary transform processing ends and the processing returns to FIG. 22.

### Flow of Primary Horizontal Transform Processing

A flow of the primary horizontal transform processing executed in step S261 in FIG. 23 will be described with reference to the flowchart in FIG. 24.

When the primary horizontal transform processing is started, the transform matrix derivation unit 281 of the primary horizontal transform unit 271 derives a transform matrix TH corresponding to the horizontal transform type index TrTypeH in step S271.

In step S272, the matrix calculation unit 282 performs the horizontal one-dimensional orthogonal transform for the input data Xₙ(prediction residual D) using the derived transform matrix T_{H} to obtain the intermediate data Y1. When this processing is expressed as a determinant, the processing can be expressed as the above-described expression (15). Furthermore, when this processing is expressed as an operation for each element, the processing can be expressed as the following expression (21).

$$[ Math . 19 ]$$

$$\begin{matrix}Y 1 [ i , j ] = {X}_{in} [ i , j ] \times {T}_{H}^{T} [ : , j ] \\ = {\sum }_{k = 0}^{N - 1} {X}_{in} [ i , k ] {T}_{H} [ j , k ]\end{matrix} \qquad ( 21 )$$

That is, an inner product of an i-th row vector Xᵢₙ [i, :] of the input data Xin and a transpose matrix T_{H}^{T}[:, j] of a j-th row vector T_{H} [j, :] of the transform matrix TH is set as the coefficient Y1 [i, j] of the i-row j-column component of the intermediate data Y1 (j=0, . . . , M−1, and i=0, . . . , N−1). Here, M represents the size of the input data Xin the x direction, and N represents the size of the input data Xin in the y direction. M and N can be expressed as the following expressions (22).

[Math. 20]

M=1<<log 2TBWSize

N=1<<log 2 TBHSize (22)

Returning to FIG. 24, in step S273, the scaling unit 283 scales, with the shift amount S_{H}, the coefficient Y1 [i, j] of each i-row j-column component of the intermediate data Y1 derived by the processing in step S272 to derive the intermediate data Y2. This scaling can be expressed as the above-described expression (16).

In step S274, the clip unit 284 clips the value of the coefficient Y2 [i, j] of each i-row j-column component of the intermediate data Y2 derived by the processing in step S273, and obtains output data Xₒᵤₜ (that is, the transform coefficient after primary horizontal transform). This processing can be expressed as the above-described expression (19).

When the processing in step S274 ends, the primary horizontal transform processing ends and the processing returns to FIG. 19.

### Flow of Transform Matrix Derivation Processing

Next, an example of a flow of transform matrix derivation processing executed in step S271 in FIG. 24 will be described with reference to the flowchart in FIG. 25.

When the transform matrix derivation processing is started, in step S281, the transform matrix derivation unit 281 obtains a base transform type BaseTrType corresponding to the horizontal transform type index TrTypeH. Note that, when this processing is expressed as a mathematical expression, the processing can be expressed as the expression (23), for example. The transform matrix derivation unit 281 reads the transform matrix of N rows and N columns of the obtained base transform type from the transform matrix LUT, and sets the transform matrix as the base transform matrix T_{base}, as in the following expression (24).

[Math. 21]

BaseTrTipe=LUT_TrTypeIdxToBaseTrType[TrTypeIdxvH] (23)

T_{base}=T[BaseTrType][log 2N−1] (24)

Furthermore, the transform matrix derivation unit 281 sets a value corresponding to the horizontal transform type index TrTypeH as a flip flag FlipFlag, as in the following expression (25). Furthermore, the transform matrix derivation unit 281 sets a value corresponding to the transform type identifier TrTypeIdxH as a transposition flag TransposeFlag, as in the following expression (26).

[Math. 22]

FlipFlag=LUT_TrTypeIdxToFlipFlag[TrTvpeIdxH] (2 5)

TransposeFlag=LUT_TrTypeIdxToTransposeFlag[TrTypeIdxH] (26)

In step S282, the transform matrix derivation unit 281 determines whether or not the flip flag FlipFlag and the transposition flag TransposeFlag satisfy a condition (ConditionA1) expressed by the following expression (27).

[Math. 23]

ConditionA1:FlipFlag==F & & TransposeFlag==F (27)

In a case where it is determined that the above-described condition (ConditionA1) is satisfied (in a case where both the flip flag FlipFlag and the transposition flag TransposeFlag are false (0)), the processing proceeds to step S283.

In step S283, the transform matrix derivation unit 281 sets the transform matrix T_{base} as the transform matrix TH as in the following expression (28).

[Math. 24]

T_{H}=T_{base} (28)

When the processing in step S283 ends, the transform matrix derivation processing ends and the processing returns to FIG. 24. Furthermore, in step S282, in a case where it is determined that the above-described condition (ConditionA1) is not satisfied (the flip flag FlipFlag or the transposition flag TransposeFlag is true (1)), the processing proceeds to step S284.

In step S284, the transform matrix derivation unit 281 determines whether or not the flip flag FlipFlag and the transposition flag TransposeFlag satisfy a condition (ConditionA2) expressed by the following expression (29).

[Math. 25]

CoditionA2:FlipF log==F & & TransposeFlag==T (29)

In a case where it is determined that the above-described condition (ConditionA2) is satisfied (in a case where the flip flag FlipFlag is false (0) and the transposition flag TransposeFlag is true (1)), the processing proceeds to step S285.

In step S285, the transform matrix derivation unit 281 transposes the base transform matrix T_{base} via the transposition unit 293 to obtain the transform matrix T_{H}. This processing can be expressed as a determinant as in the following expression (30).

[Math. 26]

T_{H}=Tr(T_{base})=T_{base}^{T} (30)

Furthermore, in a case of expressing the processing as an operation for each element, the transform matrix derivation unit 281 sets the i-row j-column component ((i, j) component) of the base transform matrix T_{base} as an (j, i) component of the transform matrix T_{H}, as in the following expression (31).

[Math. 27]

T_{H}[i,j]=T_{base}[i,j] for i,j=0, . . . ,N−1 (31)

Here, the i-row j-column component ((i, j) component) of the transform matrix T_{H} of N rows and N columns is written as T_{H} [i, j]. Furthermore, “for i, j=0, . . . , N−1” on the second row indicates that i and j have values of 0 to N−1. That is, it means that T_{H}[j, i] indicates all of elements of the transform matrix T_{H} of N rows and N columns.

By expressing the processing in step S285 as an operation for each element in this way, the transposition operation can be implemented by accessing a simple two-dimensional array. When the processing in step S285 ends, the transform matrix derivation processing ends and the processing returns to FIG. 24.

Furthermore, in step S284, in a case where it is determined that the above-described condition (ConditionA2) is not satisfied (the flip flag FlipFlag is true (1) or the transposition flag TransposeFlag is false (0)), the processing proceeds to step S286.

In step S286, the transform matrix derivation unit 281 flips the base transform matrix T_{base} via the flip unit 292 to obtain the transform matrix T_{H}. This processing can be expressed as a determinant as in the following expression (32).

[Math. 28]

T_{H}=T_{base}×J (32)

Here, x is an operator representing a matrix product. Furthermore, the flip matrix J (cross-identity matrix) is obtained by right-left inverting the N×N unit matrix I.

Furthermore, in a case of expressing the processing as an operation for each element, the transform matrix derivation unit 281 sets a (i, N−1−j) component of the base transform matrix Tbase as the i-row j-column component ((i, j) component) of the transform matrix T_{H}, as in the following expression (33).

[Math. 29]

T_{H}[i,j]=T_{base}[i,N−1−j] for i,j=0, . . . ,N−1 (33)

Here, the i-row j-column component ((i, j) component) of the transform matrix T_{H} of N rows and N columns is written as T_{H} [i, j]. Furthermore, “for i, j=0, . . . , N−1” on the second row indicates that i and j have values of 0 to N−1. That is, it means that T_{H} [i, j] indicates all of elements of the transform matrix TH of N rows and N columns.

By expressing the processing in step S286 as an operation for each element in this way, the transposition operation can be implemented by accessing a simple two-dimensional array without a matrix calculation of the base transform matrix T_{base} and the flip matrix J. Furthermore, the flip matrix J becomes unnecessary. When the processing in step S286 ends, the transform matrix derivation processing ends and the processing returns to FIG. 24.

Note that a branch described below may be inserted between the processing in step S284 and the processing in step S286. That is, in the step, the transform matrix derivation unit 281 determines whether or not the flip flag FlipFlag and the transposition flag TransposeFlag satisfy a condition (ConditionA3) expressed by the following expression (34).

[Math. 30]

ConditionA3:FlipFlag==T & & TransposeFlag==F (34)

In a case where the transform matrix derivation unit 281 determines that the above-described condition (ConditionA3) is satisfied (in a case where the flip flag FlipFlag is true (1) and the transposition flag TransposeFlag is false (0)), the processing proceeds to step S286.

Furthermore, in a case where it is determined that the above-described condition (ConditionA3) is not satisfied (the flip flag FlipFlag is false (0) or the transposition flag TransposeFlag is true (1)), the transform matrix derivation processing ends and the processing returns to FIG. 24.

### Flow of Primary Vertical Transform Processing

Next, a flow of the primary vertical transform processing executed in step S262 in FIG. 23 will be described with reference to the flowchart in FIG. 26.

When the primary vertical transform processing is started, in step S291, the transform matrix derivation unit 301 of the primary vertical transform unit 272 executes the transform matrix derivation processing to derive the transform matrix T_{V} corresponding to the vertical transform type index TrTypeV.

Since the flow of the transform matrix derivation processing is similar to the case of primary horizontal transform described with reference to the flowchart in FIG. 21, and description thereof is omitted. For example, the description regarding the horizontal direction described with reference to FIG. 21 may be replaced with description in the vertical transform type index TrTypeV, such as replacing the horizontal transform type index TrTypeH with the vertical transform type index TrTypeV, and replacing the transform matrix T_{H} for primary horizontal transform with the transform matrix T_{V} for vertical transform.

In step S292, the matrix calculation unit 302 performs the vertical one-dimensional orthogonal transform for the input data Xᵢₙ (the transform coefficient after primary horizontal transform) using the derived transform matrix T_{V} to obtain the intermediate data Y1. When this processing is expressed as a determinant, the processing can be expressed as the above-described expression (18). Furthermore, when this processing is expressed as an operation for each element, the processing can be expressed as the following expression (35).

$$[ Math . 31 ]$$

$$\begin{matrix}Y 1 [ i , j ] = {T}_{V} [ i , : ] \times {X}_{in} [ : , j ] \\ = {\sum }_{k = 0}^{N - 1} {T}_{V} [ i , k ] {X}_{in} [ k , j ]\end{matrix} \qquad ( 35 )$$

That is, in this case, an inner product of an i-th row vector T_{V} [i, :] of the transform matrix T_{V} and a j-th column vector Xin [;, j] of the input data Xin as the coefficient Y1 [i, j] of the i-row j-column component of the intermediate data Y1 (j=0, . . . , M−1, and i=0, . . . , N−1).

In step S293, the scaling unit 303 scales, with the shift amount S_{V}, the coefficient Y1 [i, j] of each i-row j-column component of the intermediate data Y1 derived by the processing in step S292 to derive the intermediate data Y2. This scaling can be expressed as the above-described expression (19).

In step S294, the clip unit 304 clips the value of the coefficient Y2 [i, j] of each i-row j-column component of the intermediate data Y2 derived by the processing in step S293 and obtains output data Xₒᵤₜ (that is, the transform coefficient after primary vertical transform). This processing can be expressed as the above-described expression (20).

When the processing in step S294 ends, the primary vertical transform processing ends and the processing returns to FIG. 23.

### Application of Present Technology

In the image encoding device 200 having the above configuration, the control unit 201 performs processing to which the above-described present technology is applied. That is, the control unit 201 has a similar configuration to the transform type derivation device 100 and can perform processing as described in the first to fourth embodiments.

### Application of Method #1

For example, the control unit 201 may include a processing unit (also referred to as transform type derivation unit) having a function similar to the transform type derivation device 100 as illustrated in FIG. 2, and the transform type derivation unit may derive the transform type, applying the method #1. That is, the transform type derivation unit may select a transform type candidate table according to the block size of the current block and derive the transform type using the selected transform type candidate table.

In that case, various types of information such as the transform flag Emtflag, mode information, block size, color identifier, transform index EmtIdx, primary horizontal transform specification flag pt_hor_flag, and primary vertical transform specification flag pt_ver_flag are generated by the control unit 201 and are supplied to the transform type derivation unit.

Furthermore, the transform types trTypeH and trTypeV set by the transform type setting unit 104 of the transform type derivation unit are supplied to the orthogonal transform unit 213. More specifically, the transform type trTypeH is supplied to the primary horizontal transform unit 271 of the primary transform unit 261, and the transform type trTypeV is supplied to the primary vertical transform unit 272. More specifically, the transform type trTypeH is supplied to the transform matrix derivation unit 281 and used for derivation of the transform matrix T_{H}. Furthermore, the transform type trTypeV is supplied to the transform matrix derivation unit 301 and used for derivation of the transform matrix T_{V}.

In the image encoding processing, in step S204 (FIG. 21), the transform type setting processing described with reference to the flowchart in FIG. 4 is performed as one of the orthogonal transform control processing, and the transform types trTypeH and trTypeV are set. Then, the derivation of the transform matrix T_{H} performed in step S271 in FIG. 24 is performed using the transform type trTypeH derived by the transform type setting processing. Furthermore, the derivation of the transform matrix T_{V} performed in step S291 in FIG. 26 is performed using the transform type trTypeV derived by the transform type setting processing.

By doing so, the image encoding device 200 can improve the coding efficiency, as described in the first embodiment. Furthermore, since the transform type candidate table is selected on the basis of the block size, the image encoding device 200 can more easily improve the coding efficiency. Moreover, since the image encoding device 200 can derive another transform matrix from a certain transform matrix, thereby suppressing an increase in sizes of the transform matrix LUT 291 and the transform matrix LUT 311 (reducing the sizes). Furthermore, since the calculation circuit for performing matrix calculation can be commonalized, an increase in the circuit scales of the matrix calculation unit 282 and the matrix calculation unit 302 can be suppressed (the circuit scales can be reduced).

### Application of Method #2

For example, the control unit 201 may include a processing unit (also referred to as transform type derivation unit) having a function similar to the transform type derivation device 100 as illustrated in FIG. 7, and the transform type derivation unit may derive the transform type, applying the method #2. That is, the transform type derivation unit may select a transform type candidate table according to the RD cost and derive the transform type using the selected transform type candidate table.

In that case, various types of information such as the transform flag Emtflag, mode information, block size, color identifier, transform index EmtIdx, primary horizontal transform specification flag pt_hor_flag, and primary vertical transform specification flag pt_ver_flag are generated by the control unit 201 and are supplied to the transform type derivation unit.

Furthermore, the transform types trTypeH and trTypeV set by the transform type setting unit 104 of the transform type derivation unit are supplied to the orthogonal transform unit 213 and are used for derivation of a transform matrix, similarly to the case of applying the method #1.

Moreover, the transform type candidate table switching flag useAltTrCandFlag derived by the transform type candidate table switching flag setting unit 122 of the transform type derivation unit is supplied to the encoding unit 215 and is encoded and included in the bitstream. That is, the transform type candidate table switching flag useAltTrCandFlag is supplied to the decoding side.

In the image encoding processing, in step S204 (FIG. 21), the transform type setting processing described with reference to the flowchart in FIG. 8 is performed as one of the orthogonal transform control processing, and the transform types trTypeH and trTypeV are set. Then, the derivation of the transform matrix T_{H} performed in step S271 in FIG. 24 is performed using the transform type trTypeH derived by the transform type setting processing. Furthermore, the derivation of the transform matrix T_{V} performed in step S291 in FIG. 26 is performed using the transform type trTypeV derived by the transform type setting processing.

By doing so, the image encoding device 200 can select the transform type candidate table on the basis of the RD cost and improve the coding efficiency, as described in the second embodiment. Furthermore, in this case, the transform type candidate table switching flag useAltTrCandFlag is transmitted to the decoding side, and therefore the image encoding device 200 can explicitly control the selection of the transform type.

### Application of Method #3

For example, the control unit 201 may include a processing unit (also referred to as transform type derivation unit) having a function similar to the transform type derivation device 100 as illustrated in FIG. 11, and the transform type derivation unit may derive the transform type, applying the method #3. That is, the transform type derivation unit may select a transform type candidate table according to the inter prediction mode and derive the transform type using the selected transform type candidate table.

In that case, various types of information such as the transform flag Emtflag, mode information, block size, color identifier, inter prediction mode, transform index EmtIdx, primary horizontal transform specification flag pt_hor_flag, and primary vertical transform specification flag pt_ver_flag are generated by the control unit 201 and are supplied to the transform type derivation unit.

Furthermore, the transform types trTypeH and trTypeV set by the transform type setting unit 104 of the transform type derivation unit are supplied to the orthogonal transform unit 213 and are used for derivation of a transform matrix, similarly to the case of applying the method #1.

In the image encoding processing, in step S204 (FIG. 21), the transform type setting processing described with reference to the flowchart in FIG. 12 is performed as one of the orthogonal transform control processing, and the transform types trTypeH and trTypeV are set. Then, the derivation of the transform matrix T_{H} performed in step S271 in FIG. 24 is performed using the transform type trTypeH derived by the transform type setting processing. Furthermore, the derivation of the transform matrix T_{V} performed in step S291 in FIG. 26 is performed using the transform type trTypeV derived by the transform type setting processing.

By doing so, the image encoding device 200 can improve the coding efficiency, as described in the third embodiment. Furthermore, since the transform type candidate table is selected on the basis of the inter prediction mode, the image encoding device 200 can more easily improve the coding efficiency. Moreover, since the image encoding device 200 can derive another transform matrix from a certain transform matrix, thereby suppressing an increase in sizes of the transform matrix LUT 291 and the transform matrix LUT 311 (reducing the sizes). Furthermore, since the calculation circuit for performing matrix calculation can be commonalized, an increase in the circuit scales of the matrix calculation unit 282 and the matrix calculation unit 302 can be suppressed (the circuit scales can be reduced).

### Application of Method #4

For example, the control unit 201 may include a processing unit (also referred to as transform type derivation unit) having a function similar to the transform type derivation device 100 as illustrated in FIG. 13, and the transform type derivation unit may derive the transform type, applying the method #4. That is, the transform type derivation unit may select a transform type candidate table according to the pixel accuracy of the motion vector and derive the transform type using the selected transform type candidate table.

In that case, various types of information such as the transform flag Emtflag, mode information, block size, color identifier, pixel accuracy of the motion vector, transform index EmtIdx, primary horizontal transform specification flag pt_hor_flag, and primary vertical transform specification flag pt_ver_flag are generated by the control unit 201 and are supplied to the transform type derivation unit.

Furthermore, the transform types trTypeH and trTypeV set by the transform type setting unit 104 of the transform type derivation unit are supplied to the orthogonal transform unit 213 and are used for derivation of a transform matrix, similarly to the case of applying the method #1.

In the image encoding processing, in step S204 (FIG. 21), the transform type setting processing described with reference to the flowchart in FIG. 14 is performed as one of the orthogonal transform control processing, and the transform types trTypeH and trTypeV are set. Then, the derivation of the transform matrix T_{H} performed in step S271 in FIG. 24 is performed using the transform type trTypeH derived by the transform type setting processing. Furthermore, the derivation of the transform matrix T_{V} performed in step S291 in FIG. 26 is performed using the transform type trTypeV derived by the transform type setting processing.

By doing so, the image encoding device 200 can improve the coding efficiency, as described in the fourth embodiment. Furthermore, since the transform type candidate table is selected on the basis of the pixel accuracy of the motion vector, the image encoding device 200 can more easily improve the coding efficiency. Moreover, since the image encoding device 200 can derive another transform matrix from a certain transform matrix, thereby suppressing an increase in sizes of the transform matrix LUT 291 and the transform matrix LUT 311 (reducing the sizes). Furthermore, since the calculation circuit for performing matrix calculation can be commonalized, an increase in the circuit scales of the matrix calculation unit 282 and the matrix calculation unit 302 can be suppressed (the circuit scales can be reduced).

### 9. SIXTH EMBODIMENT

### Image Decoding Device

Furthermore, the present technology can be used for an image decoding device that decodes coded data of an image using inverse orthogonal transform. In the present embodiment, a case where the present technology is applied to such an image decoding device will be described.

FIG. 27 is a block diagram illustrating an example of a configuration of an image decoding device as one mode of the image processing apparatus to which the present technology is applied. An image decoding device 400 illustrated in FIG. 27 is a device that decodes coded data obtained by encoding a moving image. For example, the image decoding device 400 implements the technology described in Non-Patent Documents 1 to 4, and decodes coded data that is encoded image data of a moving image encoded by a method conforming to the standard described in any of the aforementioned documents. For example, the image decoding device 400 decodes the coded data (bitstream) generated by the above-described image encoding device 200.

Note that FIG. 27 illustrates main processing units, data flows, and the like, and those illustrated in FIG. 27 are not necessarily everything. That is, in the image decoding device 400, there may be a processing unit not illustrated as a block in FIG. 27, or processing or data flow not illustrated as an arrow or the like in FIG. 27. This is similar in other drawings for describing a processing unit and the like in the image decoding device 400.

In FIG. 27, the image decoding device 400 includes an accumulation buffer 411, a decoding unit 412, an inverse quantization unit 413, an inverse orthogonal transform unit 414, a calculation unit 415, an in-loop filter unit 416, a rearrangement buffer 417, a frame memory 418, and a prediction unit 419. Note that the prediction unit 419 includes an intra prediction unit and an inter prediction unit (not illustrated). The image decoding device 400 is a device for generating moving image data by decoding coded data (bitstream).

### Accumulation Buffer

The accumulation buffer 411 acquires the bitstream input to the image decoding device 400 and holds (stores) the bitstream. The accumulation buffer 411 supplies the accumulated bitstream to the decoding unit 412 at predetermined timing or in a case where a predetermined condition is satisfied, for example.

### Decoding Unit

The decoding unit 412 performs processing regarding image decoding. For example, the decoding unit 412 receives the bitstream supplied from the accumulation buffer 411 as an input, and performs variable length decoding for a syntax value of each syntax element from the bit string according to a definition of a syntax table to derive a parameter.

The parameter derived from the syntax element and the syntax value of the syntax element includes, for example, information such as header information Hinfo, prediction mode information Pinfo, transform information Tinfo, residual information Rinfo, and filter information Finfo. That is, the decoding unit 412 parses (analyzes and acquires) such information from the bitstream. These pieces of information will be described below.

### Header Information Hinfo

The header information Hinfo includes, for example, header information such as a video parameter set (VPS)/a sequence parameter set (SPS)/a picture parameter set (PPS)/a slice header (SH). The header information Hinfo includes, for example, information defining image size (width PicWidth and height PicHeight), bit depth (luminance bitDepthY and chrominance bitDepthC), a chrominance array type ChromaArrayType, CU size maximum value MaxCUSize/minimum value MinCUSize, maximum depth MaxQTDepth/minimum depth MinQTDepth of quad-tree division, maximum depth MaxBTDepth/minimum depth MinBTDepth of binary-tree division, a maximum value MaxTSSize of a transform skip block (also called maximum transform skip block size), an on/off flag of each coding tool (also called valid flag), and the like.

For example, an example of the on/off flag of the coding tool included in the header information Hinfo includes an on/off flag related to transform and quantization processing below. Note that the on/off flag of the coding tool can also be interpreted as a flag indicating whether or not a syntax related to the coding tool exists in the coded data. Furthermore, in a case where a value of the on/off flag is 1 (true), the value indicates that the coding tool is available. In a case where the value of the on/off flag is 0 (false), the value indicates that the coding tool is not available. Note that the interpretation of the flag value may be reversed.

An inter-component prediction enabled flag (ccp_enabled_flag) is flag information indicating whether or not inter-component prediction (cross-component prediction (CCP)) is available. For example, in a case where the flag information is “1” (true), the flag information indicates that the inter-component prediction is available. In a case where the flag information is “0” (false), the flag information indicates that the inter-component prediction is not available.

Note that this CCP is also referred to as inter-component linear prediction (CCLM or CCLMP).

### Prediction Mode Information Pinfo

The prediction mode information Pinfo includes, for example, information such as size information PBSize (prediction block size) of a prediction block (PB) to be processed, intra prediction mode information IPinfo, and motion prediction information MVinfo.

The intra prediction mode information IPinfo includes, for example, prev_intra_luma_pred_flag, mpm_idx, and rem_intra_pred_mode in JCTVC-W1005, 7.3.8.5 Coding Unit syntax, a luminance intra prediction mode IntraPredModeY derived from the syntax, and the like.

Furthermore, the intra prediction mode information IPinfo includes, for example, an inter-component prediction flag (ccp_flag (cclmp_flag)), a multi-class linear prediction mode flag (mclm_flag), a chrominance sample position type identifier (chroma_sample_loc_type_idx), a chrominance MPM identifier (chroma_mpm_idx), a luminance intra prediction mode (IntraPredModeC) derived from these syntaxes, and the like.

The inter-component prediction flag (ccp_flag (cclmp_flag)) is flag information indicating whether or not to apply inter-component linear prediction. For example, ccp_flag==1 indicates that inter-component prediction is applied, and ccp_flag==0 indicates that the inter-component prediction is not applied.

The multi-class linear prediction mode flag (mclm_flag) is information regarding a linear prediction mode (linear prediction mode information). More specifically, the multi-class linear prediction mode flag (mclm_flag) is flag information indicating whether or not to set a multi-class linear prediction mode. For example, “0” indicates one-class mode (single glass mode) (for example, CCLMP), and “1” indicates two-class mode (multiclass mode) (for example, MCLMP).

The chrominance sample position type identifier (chroma_sample_loc_type_idx) is an identifier for identifying a type of a pixel position of a chrominance component (also referred to as a chrominance sample position type). For example, in a case where the chrominance array type (ChromaArrayType), which is information regarding a color format, indicates 420 format, the chrominance sample position type identifier is assigned as in the following expression (36).

[Math. 32]

chroma_sample_loc_type_idx==0Type2

chroma_sample_loc_type_idx==1Type3

chroma_sample_loc_type_idc==2Type0

chroma_sample_loc_type_idc==3:Type1 (36)

Note that the chrominance sample position type identifier (chroma_sample_loc_type_idx) is transmitted as (by being stored in) information (chroma_sample_loc_info ( )) regarding the pixel position of the chrominance component.

The chrominance MPM identifier (chroma_mpm_idx) is an identifier indicating which prediction mode candidate in a chrominance intra prediction mode candidate list (intraPredModeCandListC) is to be specified as a chrominance intra prediction mode.

The motion prediction information MVinfo includes, for example, information such as merge_idx, merge_flag, inter_pred_idc, ref_idx_LX, mvp_lX_flag, X={0,1}, mvd, and the like (see, for example, JCTVC-W1005, 7.3.8.6 Prediction Unit Syntax).

Of course, the information included in the prediction mode information Pinfo is arbitrary, and information other than the above information may be included.

### Transform Information Tinfo

The transform information Tinfo includes, for example, the following information. Of course, the information included in the transform information Tinfo is arbitrary, and information other than the above information may be included:

The width TBWSize and the height TBHSize of the transform block to be processed (or may be logarithmic values log 2 TBWSize and log 2 TBHSize of TBWSize and TBHSize having a base of 2);

a transform skip flag (ts_flag): a flag indicating whether or not to skip (inverse) primary transform and (inverse) secondary transform;

a scan identifier (scanIdx);

a quantization parameter (qp); and

a quantization matrix (scaling_matrix (for example, JCTVC-W1005, 7.3.4 Scaling list data syntax)).

### Residual Information Rinfo

The residual information Rinfo (for example, see 7.3.8.11 Residual Coding syntax of JCTVC-W1005) includes, for example, the following syntaxes:

cbf (coded_block_flag): a residual data presence/absence flag;

last_sig_coeff_x_pos: a last nonzero coefficient X coordinate;

last_sig_coeff_y_pos: a last nonzero coefficient Y coordinate;

coded_sub_block_flag: a subblock nonzero coefficient presence/absence flag;

sig_coeff flag: a nonzero coefficient presence/absence flag;

gr1_flag: a flag indicating whether or not the level of the nonzero coefficient is greater than 1 (also called GR1 flag);

gr2_flag: a flag indicating whether or not the level of the nonzero coefficient is greater than 2 (also called GR2 flag);

sign_flag: a code indicating the sign of nonzero coefficient (also called sign code);

coeff_abs_level_remaining: a residual level of the nonzero coefficient (also called nonzero coefficient residual level), and the like.

Of course, the information included in the residual information Rinfo is arbitrary, and information other than the above information may be included.

### Filter Information Finfo

The filter information Finfo includes, for example, control information regarding the following filtering processing:

control information regarding a deblocking filter (DBF);

control information regarding a pixel adaptive offset (SAO);

control information regarding an adaptive loop filter (ALF); and

control information regarding other linear and nonlinear filters.

More specifically, the filter information Finfo includes, for example, a picture to which each filter is applied, information for specifying an area in the picture, filter on/off control information for each CU, filter on/off control information for slice and tile boundaries, and the like. Of course, the information included in the filter information Finfo is arbitrary, and information other than the above information may be included.

Return to the description of the decoding unit 412. The decoding unit 412 refers to the residual information Rinfo and derives the quantized transform coefficient level level at each coefficient position in each transform block. The decoding unit 412 supplies the quantized transform coefficient level level to the inverse quantization unit 413.

Furthermore, the decoding unit 412 supplies the parsed header information Hinfo, prediction mode information Pinfo, quantized transform coefficient level level, transform information Tinfo, and filter information Finfo to each block. Specific description is given as follows.

The header information Hinfo is supplied to the inverse quantization unit 413, the inverse orthogonal transform unit 414, the prediction unit 419, and the in-loop filter unit 416.

The prediction mode information Pinfo is supplied to the inverse quantization unit 413 and the prediction unit 419.

The transform information Tinfo is supplied to the inverse quantization unit 413 and the inverse orthogonal transform unit 414.

The filter information Finfo is supplied to the in-loop filter unit 416.

Of course, the above example is an example, and the present embodiment is not limited to this example. For example, each encoding parameter may be supplied to an arbitrary processing unit. Furthermore, other information may be supplied to an arbitrary processing unit.

### Control of Inverse Orthogonal Transform

The decoding unit 412 also decodes and derives information regarding control of inverse orthogonal transform. The decoding unit 412 supplies the thus obtained information to the inverse orthogonal transform unit 414 to control the inverse orthogonal transform performed by the inverse orthogonal transform unit 414.

### Inverse Quantization Unit

The inverse quantization unit 413 has at least a configuration necessary for performing processing regarding the inverse quantization. For example, the inverse quantization unit 413 receives the transform information Tinfo and the quantized transform coefficient level level supplied from the decoding unit 412 as inputs, and, on the basis of the transform information Tinfo, scales (inversely quantizes) the value of the quantized transform coefficient level level to derive a transform coefficient Coeff_IQ after inverse quantization.

Note that this inverse quantization is performed as inverse processing of the quantization by the quantization unit 214. Furthermore, the inverse quantization is processing similar to the inverse quantization performed by the inverse quantization unit 217. That is, the inverse quantization unit 217 performs processing (inverse quantization) similar to the inverse quantization unit 413.

The inverse quantization unit 413 supplies the derived transform coefficient Coeff_IQ to the inverse orthogonal transform unit 414.

### Inverse Orthogonal Transform Unit

The inverse orthogonal transform unit 414 performs processing regarding inverse orthogonal transform. For example, the inverse orthogonal transform unit 414 receives the transform coefficient Coeff_IQ supplied from the inverse quantization unit 413 and the transform information Tinfo supplied from the decoding unit 412 as inputs, and performs the inverse orthogonal transform processing for the transform coefficient Coeff_IQ on the basis of the transform information Tinfo to derive the prediction residual D′.

Note that this inverse orthogonal transform is performed as inverse processing of the orthogonal transform by the orthogonal transform unit 213. Furthermore, the inverse orthogonal transform is processing similar to the inverse orthogonal transform performed by the inverse orthogonal transform unit 218. That is, the inverse orthogonal transform unit 218 performs processing (inverse orthogonal transform) similar to the inverse orthogonal transform unit 414.

The inverse orthogonal transform unit 414 supplies the derived prediction residual D′ to the calculation unit 415.

### Calculation Unit

The calculation unit 415 performs processing regarding addition of information regarding an image. For example, the calculation unit 415 receives the prediction residual D′ supplied from the inverse orthogonal transform unit 414 and the predicted image P supplied from the prediction unit 419 as inputs. The calculation unit 415 adds the prediction residual D′ and the predicted image P (prediction signal) corresponding to the prediction residual D′ to derive the locally decoded image R_{local}, as illustrated in the following expression (37).

[Math. 33]

R_{local}=D′+P (37)

The calculation unit 415 supplies the derived locally decoded image R_{local} to the in-loop filter unit 416 and the frame memory 418.

### In-Loop Filter Unit

The in-loop filter unit 416 performs processing regarding in-loop filter processing. For example, the in-loop filter unit 416 receives the locally decoded image R_{local} supplied from the calculation unit 415 and the filter information Finfo supplied from the decoding unit 412 as inputs. Note that the information input to the in-loop filter unit 416 may be information other than the aforementioned information.

The in-loop filter unit 416 appropriately performs filtering processing for the locally decoded image R_{local}. on the basis of the filter information Finfo.

For example, the in-loop filter unit 416 applies four in-loop filters of a bilateral filter, a deblocking filter (DBF), an adaptive offset filter (sample adaptive offset (SAO)), and an adaptive loop filter (adaptive loop filter (ALF)) in this order, as described in Non-Patent Document 1. Note that which filter is applied and in which order the filters are applied are arbitrary and can be selected as appropriate.

The in-loop filter unit 416 performs filtering processing corresponding to the filtering processing performed on the encoding side (for example, by an in-loop filter unit 220 of the image encoding device 200). Of course, the filtering processing performed by the in-loop filter unit 416 is arbitrary, and is not limited to the above example. For example, the in-loop filter unit 416 may apply a Wiener filter or the like.

The in-loop filter unit 416 supplies the filtered locally decoded image R_{local} to the rearrangement buffer 417 and the frame memory 418.

### Rearrangement Buffer

The rearrangement buffer 417 receives the locally decoded image R_{local} supplied from the in-loop filter unit 416 as an input and holds (stores) the locally decoded image R_{local}. The rearrangement buffer 417 reconstructs the decoded image R for each unit of picture, using the locally decoded image R_{local}, and holds (stores) the decoded image R (in the buffer). The rearrangement buffer 417 rearranges the obtained decoded images R from the decoding order to the reproduction order. The rearrangement buffer 417 outputs a rearranged decoded image R group to the outside of the image decoding device 400 as moving image data.

### Frame Memory

The frame memory 418 performs processing regarding storage of data relating to an image. For example, the frame memory 418 receives the locally decoded image R_{local} supplied from the calculation unit 415 as an input, reconstructs the decoded image R for each unit of picture, and stores the decoded image R in the buffer in the frame memory 418.

Furthermore, the frame memory 418 receives the in-loop filtered locally decoded image R_{local} supplied from the in-loop filter unit 416 as an input, reconstructs the decoded image R for each unit of picture, and stores the decoded image R in the buffer in the frame memory 418. The frame memory 418 appropriately supplies the stored decoded image R (or a part thereof) to the prediction unit 419 as a reference image.

Note that the frame memory 418 may store the header information Hinfo, the prediction mode information Pinfo, the transform information Tinfo, the filter information Finfo, and the like related to generation of the decoded image.

### Prediction Unit

The prediction unit 419 performs processing regarding generation of a predicted image. For example, the prediction unit 419 receives the prediction mode information Pinfo supplied from the decoding unit 412 as an input, and performs prediction by a prediction method specified by the prediction mode information Pinfo to derive the predicted image P. At the time of derivation, the prediction unit 419 uses the decoded image R (or a part thereof) before filtering or after filtering stored in the frame memory 418, the decoded image R being specified by the prediction mode information Pinfo, as the reference image. The prediction unit 419 supplies the derived predicted image P to the calculation unit 415.

### Details of Inverse Orthogonal Transform Unit

FIG. 28 is a block diagram illustrating a main configuration example of the inverse orthogonal transform unit 414 in FIG. 27. As illustrated in FIG. 28, the inverse orthogonal transform unit 414 includes an inverse secondary transform unit 461 and an inverse primary transform unit 462.

The inverse secondary transform unit 461 has at least a configuration necessary for performing processing regarding inverse secondary transform that is inverse processing of secondary transform performed on the encoding side (for example, by a secondary transform unit 262 of the image encoding device 200). For example, the inverse secondary transform unit 461 receives the transform coefficient Coeff_IQ and the transform information Tinfo supplied from the inverse quantization unit 413 as inputs.

The inverse secondary transform unit 461 performs inverse secondary transform for the transform coefficient Coeff_IQ on the basis of the transform information Tinfo to derive a transform coefficient Coeff_IS after inverse secondary transform. The inverse secondary transform unit 461 supplies the inverse secondary transform coefficient Coeff_IS to the inverse primary transform unit 462.

The inverse primary transform unit 462 performs processing related to inverse primary transform that is inverse processing of the primary transform performed on the encoding side (for example, by a primary transform unit 261 of the image encoding device 200). For example, the inverse primary transform unit 462 receives the transform coefficient Coeff_IS after inverse secondary transform, and transform type indices (vertical transform type index TrTypeV and horizontal transform type index TrTypeH) as inputs.

The inverse primary transform unit 462 performs inverse primary transform for the transform coefficient Coeff_IS after inverse secondary transform to derive a transform coefficient after inverse primary transform (that is, a prediction residual D′) using a transform matrix corresponding to the horizontal transform type index TrTypeH and a transform matrix corresponding to the vertical transform type index TrTypeV. The inverse primary transform unit 462 supplies the derived prediction residual D′ to the calculation unit 415.

As illustrated in FIG. 28, the inverse primary transform unit 462 includes an inverse primary vertical transform unit 471 and an inverse primary horizontal transform unit 472.

The inverse primary vertical transform unit 471 is configured to perform processing regarding inverse primary vertical transform that is inverse one-dimensional orthogonal transform in the vertical direction. For example, the inverse primary vertical transform unit 471 receives the transform coefficient Coeff_IS and the transform information Tinfo (vertical transform type index TrTypeV and the like) as inputs. The inverse primary vertical transform unit 471 performs the inverse primary vertical transform for the transform coefficient Coeff_IS, using the transform matrix corresponding to the vertical transform type index TrTypeV. The inverse primary vertical transform unit 471 supplies the transform coefficient after inverse primary vertical transform to the inverse primary horizontal transform unit 472.

The inverse primary horizontal transform unit 472 is configured to perform processing regarding primary horizontal transform that is one-dimensional orthogonal transform in the horizontal direction. For example, the inverse primary horizontal transform unit 472 receives the transform coefficient after inverse primary vertical transform and the transform information Tinfo (horizontal transform type index TrTypeH and the like) as inputs. The inverse primary horizontal transform unit 472 performs the inverse primary horizontal transform for the transform coefficient after inverse primary vertical transform using the transform matrix corresponding to the horizontal transform type index TrTypeH. The inverse primary horizontal transform unit 472 supplies the transform coefficient (that is, the prediction residual D′) after inverse primary horizontal transform to the calculation unit 415.

Note that the inverse orthogonal transform unit 414 can skip (omit) one or both of the inverse secondary transform by the inverse secondary transform unit 461 and the inverse primary transform by the inverse primary transform unit 462. Furthermore, the inverse primary vertical transform by the inverse primary vertical transform unit 471 may be skipped (omitted). Similarly, the inverse primary horizontal transform by the inverse primary horizontal transform unit 472 may be able to be skipped (omitted).

### Inverse Primary Vertical Transform Unit

FIG. 29 is a block diagram illustrating a main configuration example of the inverse primary vertical transform unit 471 in FIG. 28. As illustrated in FIG. 29, the inverse primary vertical transform unit 471 includes a transform matrix derivation unit 481, a matrix calculation unit 482, a scaling unit 483, and a clip unit 484.

The transform matrix derivation unit 481 receives the vertical transform type index TrTypeV and the information regarding the size of the transform block as inputs, and derives a transform matrix T_{V} for inverse primary vertical transform (a transform matrix T_{V} for vertical inverse one-dimensional orthogonal transform) having the same size as the transform block, the transform matrix T_{V} corresponding to the vertical transform type index TrTypeV. The transform matrix derivation unit 481 supplies the transform matrix T_{V} to the matrix calculation unit 482.

The matrix calculation unit 482 performs the vertical inverse one-dimensional orthogonal transform for the input data X1 (that is, the transform block of the transform coefficient Coeff_IS after inverse secondary transform), using the transform matrix T_{V} supplied from the transform matrix derivation unit 481, to obtain intermediate data Y1. This calculation can be expressed by a determinant as in the following expression (38).

[Math. 34]

Y1=T_{V}^{T}Xᵢₙ (38)

The matrix calculation unit 482 supplies the intermediate data Y1 to the scaling unit 483.

The scaling unit 483 scales a coefficient Y1 [i, j] of each i-row j-column component of the intermediate data Y1 with a predetermined shift amount S_{IV} to obtain intermediate data Y2. This scaling can be expressed as the following expression (39).

[Math. 35]

Y2[i,j]=Y1[i,j]>>S_{IV} (39)

The scaling unit 483 supplies the intermediate data Y2 to the clip unit 484.

The clip unit 484 clips a value of a coefficient Y2 [i, j] of each i-row j-column component of the intermediate data Y2, and derives output data Xₒᵤₜ (that is, the transform coefficient after inverse primary vertical transform). This processing can be expressed as the above-described expression (20).

The clip unit 484 outputs the output data Xₒᵤₜ (the transform coefficient after inverse primary vertical transform) to the outside of the inverse primary vertical transform unit 471 (supplies the same to the inverse primary horizontal transform unit 472).

### Transform Matrix Derivation Unit

FIG. 30 is a block diagram illustrating a main configuration example of the transform matrix derivation unit 481 in FIG. 29. As illustrated in FIG. 30, the transform matrix derivation unit 481 includes a transform matrix LUT 491, a flip unit 492, and a transposition unit 493. Note that, in FIG. 30, arrows representing data transfer are omitted, but in the transform matrix derivation unit 481, arbitrary data can be transferred between arbitrary processing units (processing blocks).

The transform matrix LUT 491 is a lookup table for holding (storing) a transform matrix corresponding to the vertical transform type index TrTypeV and the size N of the transform block. When the vertical transform type index TrTypeV and the size N of the transform block are specified, the transform matrix LUT 491 selects and outputs a transform matrix corresponding thereto. In the case of this derivation example, the transform matrix LUT 491 supplies the transform matrix to both or one of the flip unit 492 and the transposition unit 493 as the base transform matrix T_{base}.

The flip unit 492 flips an input transform matrix T of N rows and N columns, and outputs a flipped transform matrix Trip. In the case of this derivation example, the flip unit 492 receives the base transform matrix T_{base} of N rows and N columns supplied from the transform matrix LUT 491 as an input, flips the base transform matrix Tbase in the row direction (horizontal direction), and outputs the flipped transform matrix T_{flip} to the outside of the transform matrix derivation unit 481 (supplies the same to the matrix calculation unit 482) as the transform matrix T_{V}.

The transposition unit 493 transposes the input transform matrix T of N rows and N columns, and outputs a transposed transform matrix Tₜᵣₐₙₛₚₒₛₑ. In the case of this derivation example, the transposition unit 493 receives the base transform matrix T_{base} of N rows and N columns supplied from the transform matrix LUT 491 as an input, transposes the base transform matrix T_{base}, and outputs the transposed transform matrix Tₜᵣₐₙₛₚₒₛₑ to the outside of the transform matrix derivation unit 481 (supplies the same to the matrix calculation unit 482) as the transform matrix T_{V}.

### Inverse Primary Horizontal Transform Unit

FIG. 31 is a block diagram illustrating a main configuration example of the inverse primary horizontal transform unit 472 in FIG. 28. As illustrated in FIG. 31, the inverse primary horizontal transform unit 472 includes a transform matrix derivation unit 501, a matrix calculation unit 502, a scaling unit 503, and a clip unit 504.

The transform matrix derivation unit 501 receives the horizontal transform type index TrTypeH and the information regarding the size of the transform block as inputs, and derives a transform matrix T_{H} for horizontal transform (a transform matrix T_{H} for horizontal inverse one-dimensional orthogonal transform) having the same size as the transform block, the transform matrix T_{H} corresponding to the horizontal transform type index TrTypeH. The transform matrix derivation unit 501 supplies the transform matrix T_{H} to the matrix calculation unit 502.

The matrix calculation unit 502 performs the horizontal inverse one-dimensional orthogonal transform for the input data Xᵢₙ (that is, the transform block of the transform coefficient after inverse primary vertical transform), using the transform matrix TH supplied from the transform matrix derivation unit 501, to obtain intermediate data Y1. This calculation can be expressed by a determinant as in the following expression (40).

[Math. 36]

Y1=Xᵢₙ×T_{H} (40)

The matrix calculation unit 502 supplies the intermediate data Y1 to the scaling unit 503.

The scaling unit 503 scales a coefficient Y1 [i, j] of each i-row j-column component of the intermediate data Y1 with a predetermined shift amount S_{IH} to obtain intermediate data Y2. This scaling can be expressed as the following expression (41).

[Math. 37]

Y2[i,j]=Y1[i,j]>>S_{IH} (41)

The scaling unit 503 supplies the intermediate data Y2 to the clip unit 504.

The clip unit 504 clips a value of a coefficient Y2 [i, j] of each i-row j-column component of the intermediate data Y2, and derives output data Xₒᵤₜ (that is, the transform coefficient after inverse primary horizontal transform). This processing can be expressed as the above-described expression (15).

The clip unit 504 outputs the output data Xₒᵤₜ (the transform coefficient after inverse primary horizontal transform (transform coefficient Coeff_IP after inverse primary transform)) to the outside of the inverse primary horizontal transform unit 472 (supplies the same to the calculation unit 415) as a prediction residual D′.

### Transform Matrix Derivation Unit

FIG. 32 is a block diagram illustrating a main configuration example of the transform matrix derivation unit 501 in FIG. 31. As illustrated in FIG. 32, the transform matrix derivation unit 501 includes a transform matrix LUT 511, a flip unit 512, and a transposition unit 513. Note that, in FIG. 32, arrows representing data transfer are omitted, but in the transform matrix derivation unit 501, arbitrary data can be transferred between arbitrary processing units (processing blocks).

The transform matrix LUT 511 is a lookup table for holding (storing) a transform matrix corresponding to the horizontal transform type index TrTypeIdxH and the size N of the transform block. When the horizontal transform type index TrTypeIdxH and the size N of the transform block are specified, the transform matrix LUT 511 selects and outputs a transform matrix corresponding thereto. In the case of this derivation example, the transform matrix LUT 511 supplies the transform matrix to both or one of the flip unit 512 and the transposition unit 513 as the base transform matrix Tbase.

The flip unit 512 flips an input transform matrix T of N rows and N columns, and outputs a flipped transform matrix T_{flip}. In the case of this derivation example, the flip unit 512 receives the base transform matrix T_{base} of N rows and N columns supplied from the transform matrix LUT 511 as an input, flips the base transform matrix Tbase in the row direction (horizontal direction), and outputs the flipped transform matrix T_{flip} to the outside of the transform matrix derivation unit 501 (supplies the same to the matrix calculation unit 502) as the transform matrix T_{H}.

The transposition unit 513 transposes the input transform matrix T of N rows and N columns, and outputs a transposed transform matrix Tₜᵣₐₙₛₚₒₛₑ. In the case of this derivation example, the transposition unit 513 receives the base transform matrix T_{base} of N rows and N columns supplied from the transform matrix LUT 511 as an input, transposes the base transform matrix T_{base}, and outputs the transposed transform matrix Tₜᵣₐₙₛₚₒₛₑ to the outside of the transform matrix derivation unit 501 (supplies the same to the matrix calculation unit 502) as the transform matrix T_{H}.

### Flow of Image Decoding Processing

Next, a flow of each processing executed by the image decoding device 400 having the above configuration will be described. First, an example of a flow of image encoding processing will be described with reference to the flowchart in FIG. 33.

When the image decoding processing is started, in step S401, the accumulation buffer 411 acquires and holds (accumulates) the coded data (bitstream) supplied from the outside of the image decoding device 400.

In step S402, the decoding unit 412 decodes the coded data (bitstream) to obtain a quantized transform coefficient level level. Furthermore, the decoding unit 412 parses (analyzes and acquires) various encoding parameters from the coded data (bitstream) by this decoding.

In step S403, the decoding unit 412 performs inverse orthogonal transform control processing of controlling the type of inverse orthogonal transform according to the encoding parameter.

In step S404, the inverse quantization unit 413 performs inverse quantization that is inverse processing of the quantization performed on the encoding side for the quantized transform coefficient level level obtained by the processing in step S402 to obtain the transform coefficient Coeff_IQ.

In step S405, the inverse orthogonal transform unit 414 performs inverse orthogonal transform processing that is inverse processing of the orthogonal transform processing performed on the encoding side for the transform coefficient Coeff_IQ obtained by the processing in step S404 to obtain the prediction residual D′ according to the control in step S403.

In step S406, the prediction unit 419 executes prediction processing by a prediction method specified on the encoding side on the basis of the information parsed in step S402, and generates a predicted image P, for example, by reference to the reference image stored in the frame memory 418.

In step S407, the calculation unit 415 adds the prediction residual D′ obtained in step S405 and the predicted image P obtained in step S406 to derive a locally decoded image R_{local}.

In step S408, the in-loop filter unit 416 performs the in-loop filter processing for the locally decoded image R_{local} obtained by the processing in step S407.

In step S409, the rearrangement buffer 417 derives a decoded image R, using the filtered locally decoded image Rlocal obtained by the processing in step S408, and rearranges a decoded image R group from the decoding order to the reproduction order. The decoded image R group rearranged in the reproduction order is output to the outside of the image decoding device 400 as a moving image.

Furthermore, in step S410, the frame memory 418 stores at least one of the locally decoded image R_{local} obtained by the processing in step S407, or the locally decoded image R_{local} after filtering processing obtained by the processing in step S408.

When the processing in step S410 is completed, the image decoding processing is completed.

### Flow of Inverse Orthogonal Transform Processing

Next, an example of a flow of the inverse orthogonal transform processing executed in step S405 in FIG. 33 will be described with reference to the flowchart in FIG. 34. When the inverse orthogonal transform processing is started, in step S441, the inverse orthogonal transform unit 414 determines whether the transform skip flag ts_flag is 2D_TS (in a mode of two-dimensional transform skip) (for example, 1 (true)) or the transform quantization bypass flag transquant_bypass_flag is 1 (true). In a case where it is determined that the transform skip identifier ts_idx is 2D_TS or the transform quantization bypass flag is 1 (true), the inverse orthogonal transform processing ends, and the processing returns to FIG. 33. In this case, the inverse orthogonal transform processing (the inverse primary transform and the inverse secondary transform) is omitted, and the transform coefficient Coeff_IQ is adopted as the prediction residual D′.

Furthermore, in step S441, in a case where it is determined that the transfer skip identifier ts_idx is not 2D_TS (a mode other than the two-dimensional transform skip) (for example, 0 (false)), and the transform quantization bypass flag is 0 (false), the processing proceeds to step S442. In this case, the inverse secondary transform processing and the inverse primary transform processing are performed.

In step S442, the inverse secondary transform unit 461 performs the inverse secondary transform processing for the transform coefficient Coeff_IQ on the basis of the secondary transform identifier st_idx to derive a transform coefficient Coeff_IS, and outputs the transform coefficient Coeff_IS.

In step S443, the inverse primary transform unit 462 performs the inverse primary transform processing for the transform coefficient Coeff_IS to derive a transform coefficient (prediction residual D′) after inverse primary transform.

When the processing in step S443 ends, the inverse orthogonal transform processing ends and the processing returns to FIG. 30.

### Flow of Inverse Primary Transform Processing

Next, an example of a flow of the inverse primary transform processing executed in step S443 in FIG. 34 will be described with reference to the flowchart in FIG. 35.

When the inverse primary transform processing is started, the inverse primary vertical transform unit 471 of the inverse primary transform unit 462 performs the inverse primary vertical transform for the transform coefficient Coeff_IS after inverse secondary transform to derive the transform coefficient after inverse primary vertical transform in step S451.

In step S452, the inverse primary horizontal transform unit 472 performs inverse primary horizontal transform processing for the transform coefficient after inverse primary vertical transform to derive the transform coefficient after inverse primary horizontal transform (that is, the prediction residual D′).

When the processing in step S452 ends, the inverse primary transform processing ends and the processing returns to FIG. 32.

### Flow of Inverse Primary Vertical Transform Processing

Next, an example of a flow of the inverse primary vertical transform processing executed in step S451 in FIG. 35 will be described with reference to the flowchart in FIG. 36.

When the inverse primary vertical transform processing is started, in step S461, the transform matrix derivation unit 481 of the inverse primary vertical transform unit 471 executes the transform matrix derivation processing to derive the transform matrix T_{V} corresponding to the vertical transform type index TrTypeV.

The transform matrix derivation processing in this case is performed by a flow similar to the case of the primary horizontal transform described with reference to the flowchart in FIG. 25. Therefore, the description is omitted. For example, the description made with reference to FIG. 25 can be applied as description of the transform matrix derivation processing of this case by replacing the horizontal transform type index TrTypeH with the vertical transform type index TrTypeV and replacing the transform matrix T_{H} for primary horizontal transform to be derived with the transform matrix T_{V} for inverse primary vertical transform.

In step S462, the matrix calculation unit 482 performs the vertical inverse one-dimensional orthogonal transform for the input data Xᵢₙ (that is, the transform coefficient Coeff_IS after inverse secondary transform), using the derived transform matrix T_{V}, to obtain the intermediate data Y1. When this processing is expressed as a determinant, the processing can be expressed as the above-described expression (30).

In step S463, the scaling unit 483 scales, with the shift amount S_{IV}, the coefficient Y1 [i, j] of each i-row j-column component of the intermediate data Y1 derived by the processing in step S462 to derive the intermediate data Y2. This scaling can be expressed as the above-described expression (39).

In step S464, the clip unit 484 clips the value of the coefficient Y2 [i, j] of each i-row j-column component of the intermediate data Y2 derived by the processing in step S463 and obtains output data Xₒᵤₜ (that is, the transform coefficient after inverse primary vertical transform). This processing can be expressed as the above-described expression (20).

When the processing in step S464 ends, the inverse primary vertical transform processing ends and the processing returns to FIG. 35.

### Flow of Inverse Primary Horizontal Transform Processing

Next, a flow of the inverse primary horizontal transform processing executed in step S452 in FIG. 35 will be described with reference to the flowchart in FIG. 37.

When the inverse primary horizontal transform processing is started, in step S471, the transform matrix derivation unit 501 of the inverse primary horizontal transform unit 472 executes the transform matrix derivation processing to derive the transform matrix Ti corresponding to the horizontal transform type index TrTypeH.

The transform matrix derivation processing in this case is performed by a flow similar to the case of the primary horizontal transform described with reference to the flowchart in FIG. 25. Therefore, the description is omitted. For example, the description made by reference to FIG. 25 can be applied as description of the transform matrix derivation processing of this case, by replacing the primary horizontal transform with the inverse primary horizontal transform, or the like.

In step S472, the matrix calculation unit 502 performs the horizontal inverse one-dimensional orthogonal transform for the input data Xᵢₙ (that is, the transform coefficient after inverse primary vertical transform), using the derived transform matrix Ti, to obtain the intermediate data Y1. When this processing is expressed as a determinant, the processing can be expressed as the above-described expression (32).

In step S473, the scaling unit 503 scales, with the shift amount S_{IH}, the coefficient Y1 [i, j] of each i-row j-column component of the intermediate data Y1 derived by the processing in step S472 to derive the intermediate data Y2. This scaling can be expressed as the above-described expression (33).

In step S474, the clip unit 504 clips the value of the coefficient Y2 [i, j] of each i-row j-column component of the intermediate data Y2 derived by the processing in step S473 and obtains output data X_{OUT} (that is, the prediction residual D′). This processing can be expressed as the above-described expression (12).

When the processing in step S474 ends, the inverse primary horizontal transform processing ends and the processing returns to FIG. 35.

### Application of Present Technology

In the image decoding device 400 having the above configuration, the decoding unit 412 performs processing to which the above-described present technology is applied. That is, the decoding unit 412 has a similar configuration to the transform type derivation device 100 and can perform processing as described in the first to fourth embodiments.

### Application of Method #1

For example, the decoding unit 412 may include a processing unit (also referred to as transform type derivation unit) having a function similar to the transform type derivation device 100 as illustrated in FIG. 2, and the transform type derivation unit may derive the transform type, applying the method #1. That is, the transform type derivation unit may select a transform type candidate table according to the block size of the current block and derive the transform type using the selected transform type candidate table.

In that case, various types of information such as the transform flag Emtflag, mode information, block size, color identifier, transform index EmtIdx, primary horizontal transform specification flag pt_hor_flag, and primary vertical transform specification flag pt_ver_flag are included in the bitstream and transmitted. The image decoding device 400 acquires such a bitstream. The decoding unit 412 decodes the bitstream to extract various types of information, and supplies the various types of information to the transform type derivation unit.

Furthermore, the transform types trTypeH and trTypeV set by the transform type setting unit 104 of the transform type derivation unit are supplied to the inverse orthogonal transform unit 414. More specifically, the transform type trTypeV is supplied to the inverse primary vertical transform unit 471 of the inverse primary transform unit 462 and the transform type trTypeH is supplied to the inverse primary horizontal transform unit 472. More specifically, the transform type trTypeV is supplied to the transform matrix derivation unit 481 and used for derivation of the transform matrix T_{V}. Furthermore, the transform type trTypeH is supplied to the transform matrix derivation unit 501 and used for derivation of the transform matrix TH.

In the image decoding processing, in step S403 (FIG. 33), the transform type setting processing described with reference to the flowchart in FIG. 4 is performed as one of the inverse orthogonal transform control processing, and the transform types trTypeH and trTypeV are set. Then, the derivation of the transform matrix T_{V} performed in step S461 in FIG. 36 is performed using the transform type trTypeV derived by the transform type setting processing. Furthermore, the derivation of the transform matrix T_{H} performed in step S471 in FIG. 37 is performed using the transform type trTypeH derived by the transform type setting processing.

By doing so, the image decoding device 400 can improve the coding efficiency, as described in the first embodiment. Furthermore, since the transform type candidate table is selected on the basis of the block size, the image decoding device 400 can more easily improve the coding efficiency. Moreover, since the image decoding device 400 can derive another transform matrix from a certain transform matrix, thereby suppressing an increase in sizes of the transform matrix LUT 491 and the transform matrix LUT 511 (reducing the sizes). Furthermore, since the calculation circuit for performing matrix calculation can be commonalized, an increase in the circuit scales of the matrix calculation unit 482 and the matrix calculation unit 502 can be suppressed (the circuit scales can be reduced).

### Application of Method #2

For example, the decoding unit 412 may include a processing unit (also referred to as transform type derivation unit) having a function similar to the transform type derivation device 100 as illustrated in FIG. 9, and the transform type derivation unit may derive the transform type, applying the method #2. That is, the transform type derivation unit may select the transform type candidate table on the basis of a transform type candidate table switching flag useAltTrCandFlag and derive the transform type using the selected transform type candidate table.

In that case, various types of information such as the transform flag Emtflag, mode information, block size, color identifier, the transform type candidate table switching flag useAltTrCandFlag, transform index EmtIdx, primary horizontal transform specification flag pt_hor_flag, and primary vertical transform specification flag pt_ver_flag are included in the bitstream and transmitted. The image decoding device 400 acquires such a bitstream. The decoding unit 412 decodes the bitstream to extract various types of information, and supplies the various types of information to the transform type derivation unit.

Furthermore, the transform types trTypeH and trTypeV set by the transform type setting unit 104 of the transform type derivation unit are supplied to the inverse orthogonal transform unit 414 and are used for derivation of a transform matrix, similarly to the case of applying the method #1.

In the image decoding processing, in step S403 (FIG. 33), the transform type setting processing described with reference to the flowchart in FIG. 10 is performed as one of the inverse orthogonal transform control processing, and the transform types trTypeH and trTypeV are set. Then, the derivation of the transform matrix T_{V} performed in step S461 in FIG. 36 is performed using the transform type trTypeV derived by the transform type setting processing. Furthermore, the derivation of the transform matrix T_{H} performed in step S471 in FIG. 37 is performed using the transform type trTypeH derived by the transform type setting processing.

By doing so, the image decoding device 400 can select the transform type candidate table on the basis of the transform type candidate table switching flag useAltTrCandFlag transmitted from the encoding side and improve the coding efficiency, as described in the second embodiment. Furthermore, since the transform type candidate table is selected on the basis of the transform type candidate table switching flag useAltTrCandFlag, the image decoding device 400 can more easily improve the coding efficiency.

### Application of Method #3

For example, the decoding unit 412 may include a processing unit (also referred to as transform type derivation unit) having a function similar to the transform type derivation device 100 as illustrated in FIG. 11, and the transform type derivation unit may derive the transform type, applying the method #3. That is, the transform type derivation unit may select a transform type candidate table according to the inter prediction mode and derive the transform type using the selected transform type candidate table.

In that case, various types of information such as the transform flag Emtflag, mode information, block size, color identifier, inter prediction mode, transform index EmtIdx, primary horizontal transform specification flag pt_hor_flag, and primary vertical transform specification flag pt_ver_flag are included in the bitstream and transmitted. The image decoding device 400 acquires such a bitstream. The decoding unit 412 decodes the bitstream to extract various types of information, and supplies the various types of information to the transform type derivation unit.

Furthermore, the transform types trTypeH and trTypeV set by the transform type setting unit 104 of the transform type derivation unit are supplied to the inverse orthogonal transform unit 414 and are used for derivation of a transform matrix, similarly to the case of applying the method #1.

In the image decoding processing, in step S403 (FIG. 33), the transform type setting processing described with reference to the flowchart in FIG. 12 is performed as one of the orthogonal transform control processing, and the transform types trTypeH and trTypeV are set. Then, the derivation of the transform matrix T_{V} performed in step S461 in FIG. 36 is performed using the transform type trTypeH derived by the transform type setting processing. Furthermore, the derivation of the transform matrix T_{H} performed in step S471 in FIG. 37 is performed using the transform type trTypeV derived by the transform type setting processing.

By doing so, the image decoding device 400 can improve the coding efficiency, as described in the third embodiment. Furthermore, since the transform type candidate table is selected on the basis of the inter prediction mode, the image decoding device 400 can more easily improve the coding efficiency. Moreover, since the image decoding device 400 can derive another transform matrix from a certain transform matrix, thereby suppressing an increase in sizes of the transform matrix LUT 491 and the transform matrix LUT 511 (reducing the sizes). Furthermore, since the calculation circuit for performing matrix calculation can be commonalized, an increase in the circuit scales of the matrix calculation unit 482 and the matrix calculation unit 502 can be suppressed (the circuit scales can be reduced).

### Application of Method #4

For example, the decoding unit 412 may include a processing unit (also referred to as transform type derivation unit) having a function similar to the transform type derivation device 100 as illustrated in FIG. 13, and the transform type derivation unit may derive the transform type, applying the method #4. That is, the transform type derivation unit may select a transform type candidate table according to the pixel accuracy of the motion vector and derive the transform type using the selected transform type candidate table.

In that case, various types of information such as the transform flag Emtflag, mode information, block size, color identifier, pixel accuracy of the motion vector, transform index EmtIdx, primary horizontal transform specification flag pt_hor_flag, and primary vertical transform specification flag pt_ver_flag are included in the bitstream and transmitted. The image decoding device 400 acquires such a bitstream. The decoding unit 412 decodes the bitstream to extract various types of information, and supplies the various types of information to the transform type derivation unit.

Furthermore, the transform types trTypeH and trTypeV set by the transform type setting unit 104 of the transform type derivation unit are supplied to the inverse orthogonal transform unit 414 and are used for derivation of a transform matrix, similarly to the case of applying the method #1.

In the image decoding processing, in step S403 (FIG. 33), the transform type setting processing described with reference to the flowchart in FIG. 14 is performed as one of the orthogonal transform control processing, and the transform types trTypeH and trTypeV are set. Then, the derivation of the transform matrix T_{V} performed in step S461 in FIG. 36 is performed using the transform type trTypeH derived by the transform type setting processing. Furthermore, the derivation of the transform matrix TH performed in step S471 in FIG. 37 is performed using the transform type trTypeV derived by the transform type setting processing.

By doing so, the image decoding device 400 can improve the coding efficiency, as described in the fourth embodiment. Furthermore, since the transform type candidate table is selected on the basis of the pixel accuracy of the motion vector, the image decoding device 400 can more easily improve the coding efficiency. Moreover, since the image decoding device 400 can derive another transform matrix from a certain transform matrix, thereby suppressing an increase in sizes of the transform matrix LUT 491 and the transform matrix LUT 511 (reducing the sizes). Furthermore, since the calculation circuit for performing matrix calculation can be commonalized, an increase in the circuit scales of the matrix calculation unit 482 and the matrix calculation unit 502 can be suppressed (the circuit scales can be reduced).

### 10. APPENDIX

### Computer

The above-described series of processing can be executed by hardware or by software. In the case of executing the series of processing by software, a program that configures the software is installed in a computer. Here, the computer includes a computer incorporated in dedicated hardware, a computer, for example, general-purpose personal computer, capable of executing various functions by installing various programs, and the like.

FIG. 38 is a block diagram illustrating a configuration example of hardware of a computer that executes the above-described series of processing by a program.

In a computer 800 illustrated in FIG. 38, a central processing unit (CPU) 801, a read only memory (ROM) 802, and a random access memory (RAM) 803 are mutually connected by a bus 804.

An input/output interface 810 is also connected to the bus 804. An input unit 811, an output unit 812, a storage unit 813, a communication unit 814, and a drive 815 are connected to the input/output interface 810.

The input unit 811 includes, for example, a keyboard, a mouse, a microphone, a touch panel, an input terminal, and the like. The output unit 812 includes, for example, a display, a speaker, an output terminal, and the like. The storage unit 813 includes, for example, a hard disk, a RAM disk, a nonvolatile memory, and the like. The communication unit 814 includes, for example, a network interface. The drive 815 drives a removable medium 821 such as a magnetic disk, an optical disk, a magneto-optical disk, or a semiconductor memory.

In the computer configured as described above, the CPU 801 loads, for example, a program stored in the storage unit 813 into the RAM 803 and executes the program via the input/output interface 810 and the bus 804, so that the above-described series of processing is performed. Furthermore, the RAM 803 appropriately stores data and the like necessary for the CPU 801 to execute the various types of processing.

The program executed by the computer (CPU 801) can be recorded on the removable medium 821 as a package medium or the like, for example, and applied. In that case, the program can be installed to the storage unit 813 via the input/output interface 810 by attaching the removable medium 821 to the drive 815.

Furthermore, this program can be provided via a wired or wireless transmission medium such as a local area network, the Internet, or digital satellite broadcast. In that case, the program can be received by the communication unit 814 and installed in the storage unit 813.

Other than the above method, the program can be installed in the ROM 802 or the storage unit 813 in advance.

### Units of Information and Processing

The data unit in which various types of information described above are set and the data unit to be processed by various types of processing are arbitrary, and are not limited to the above-described examples. For example, these pieces of information and processing may be set for each transform unit (TU), transform block (TB), prediction unit (PU), prediction block (PB), coding unit (CU), largest coding unit (LCU), subblock, block, tile, slice, picture, sequence, or component, or data in these data units may be used. Of course, this data unit can be set for each information and processing, and the data units of all pieces of information and processing need not to be unified. Note that the storage location of these pieces of information is arbitrary, and may be stored in a header, a parameter, or the like of the above-described data unit. Furthermore, the information may be stored in a plurality of locations.

### Control Information

Control information regarding the present technology described in the above embodiments may be transmitted from the encoding side to the decoding side. For example, control information (for example, enabled_flag) for controlling whether or not application of the above-described present technology is to be permitted (or prohibited) may be transmitted. Furthermore, for example, control information indicating an object to which the above-described present technology is applied (or an object to which the present technology is not applied) may be transmitted. For example, control information for specifying a block size (upper limit, lower limit, or both) to which the present technology is applied (or application is permitted or prohibited), a frame, a component, a layer, or the like may be transmitted.

### Applicable Object of Present Technology

The present technology can be applied to any image encoding/decoding method. That is, specifications of various types of processing regarding image encoding/decoding such as transform (inverse transform), quantization (inverse quantization), encoding (decoding), and prediction are arbitrary and are not limited to the above-described examples as long as no contradiction occurs with the above-described present technology. Furthermore, part of the processing may be omitted as long as no contradiction occurs with the above-described present technology.

Furthermore, the present technology can be applied to a multi-view image encoding/decoding system that performs encoding/decoding of a multi-view image including images of a plurality of viewpoints (views). In this case, the present technology is simply applied to encoding/decoding of each viewpoint (view).

Furthermore, the present technology can be applied to a hierarchical image encoding (scalable encoding)/decoding system that encodes/decodes a hierarchical image that is multi-layered (hierarchized) so as to have a scalability function for a predetermined parameter. In this case, the present technology is simply applied to encoding/decoding of each layer (layer).

The image processing apparatus, the image encoding device, and the image decoding device according to the above-described embodiments can be applied to, for example, transmitters and receivers (such as television receivers and mobile phones) in satellite broadcasting, cable broadcasting such as cable TV, distribution on the Internet, and distribution to terminals by cellular communication, or various electronic devices such as devices (for example, hard disk recorders and cameras) that record images on media such as optical disks, magnetic disks, and flash memories, and reproduce images from these storage media.

Furthermore, the present technology can be implemented as any configuration to be mounted on a device that configures arbitrary device or system, such as a processor (for example, a video processor) as a system large scale integration (LSI) or the like, a module (for example, a video module) using a plurality of processors or the like, a unit (for example, a video unit) using a plurality of modules or the like, or a set (for example, a video set) in which other functions are added to the unit (that is, a configuration of a part of the device), for example.

Moreover, the present technology can also be applied to a network system including a plurality of devices. For example, the present technology can be applied to a cloud service that provides a service regarding an image (moving image) to an arbitrary terminal such as a computer, an audio visual (AV) device, a portable information processing terminal, or an internet of things (IoT) device.

Note that the systems, devices, processing units, and the like to which the present technology is applied can be used in arbitrary fields such as traffic, medical care, crime prevention, agriculture, livestock industry, mining, beauty, factory, household appliance, weather, and natural surveillance, for example. Furthermore, uses in the arbitrary fields are also arbitrary.

For example, the present technology can be applied to systems and devices provided for providing content for appreciation and the like. Furthermore, for example, the present technology can also be applied to systems and devices used for traffic, such as traffic condition monitoring and automatic driving control. Moreover, for example, the present technology can also be applied to systems and devices provided for security. Furthermore, for example, the present technology can be applied to systems and devices provided for automatic control of machines and the like. Moreover, for example, the present technology can also be applied to systems and devices provided for agriculture or livestock industry. Furthermore, the present technology can also be applied to systems and devices that monitor nature states such as volcanos, forests, and ocean, wildlife, and the like. Moreover, for example, the present technology can also be applied to systems and devices provided for sports.

### Others

Note that the “flag” in the present specification is information for identifying a plurality of states, and includes not only information used for identifying two states of true (1) and false (0) but also information capable of identifying three or more states. Therefore, the value that the “flag” can take may be, for example, a binary value of I/O or may be a ternary value or more. That is, the number of bits constituting the “flag” is arbitrary, and may be 1 bit or a plurality of bits. Furthermore, the identification information (including flag) is assumed to be in not only a form of including the identification information in a bitstream but also a form of including difference information of the identification information from certain reference information in a bitstream. Therefore, in the present specification, the “flag” and “identification information” include not only the information itself but also the difference information for the reference information.

Furthermore, various types of information (metadata and the like) regarding coded data (bitstream) may be transmitted or recorded in any form as long as the various types of information are associated with the coded data. Here, the term “associate” means that, for example, one data can be used (linked) when the other data is processed. That is, data associated with each other may be collected as one data or may be individual data. For example, information associated with coded data (image) may be transmitted on a transmission path different from that of the coded data (image). Furthermore, for example, information associated with coded data (image) may be recorded on a different recording medium (or another recording area of the same recording medium) from the coded data (image). Note that this “association” may be a part of data instead of entire data. For example, an image and information corresponding to the image may be associated with each other in an arbitrary unit such as a plurality of frames, one frame, or a part in a frame.

Note that, in the present specification, terms such as “combining”, “multiplexing”, “adding”, “integrating”, “including”, “storing”, and “inserting” mean putting a plurality of things into one, such as putting coded data and metadata into one data, and means one method of the above-described “association”.

Furthermore, embodiments of the present technology are not limited to the above-described embodiments, and various modifications can be made without departing from the gist of the present technology.

Further, for example, the configuration described as one device (or processing unit) may be divided into and configured as a plurality of devices (or processing units). On the contrary, the configuration described as a plurality of devices (or processing units) may be collectively configured as one device (or processing unit). Furthermore, a configuration other than the above-described configuration may be added to the configuration of each device (or each processing unit). Moreover, a part of the configuration of a certain device (or processing unit) may be included in the configuration of another device (or another processing unit) as long as the configuration and operation of the system as a whole are substantially the same.

Note that, in this specification, the term “system” means a set of a plurality of configuration elements (devices, modules (parts), and the like), and whether or not all the configuration elements are in the same casing is irrelevant. Therefore, a plurality of devices housed in separate housings and connected via a network, and one device that houses a plurality of modules in one casing are both systems.

Further, for example, in the present technology, a configuration of cloud computing in which one function is shared and processed in cooperation by a plurality of devices via a network can be adopted.

Furthermore, for example, the above-described program can be executed by an arbitrary device. In that case, the device is only required to have necessary functions (functional blocks and the like) and obtain necessary information.

Further, for example, the steps described in the above-described flowcharts can be executed by one device or can be executed by a plurality of devices in a shared manner. Moreover, in the case where a plurality of processes is included in one step, the plurality of processes included in the one step can be executed by one device or can be shared and executed by a plurality of devices. In other words, the plurality of processes included in one step can be executed as processes of a plurality of steps. Conversely, the processing described as a plurality of steps can be collectively executed as one step.

Note that, in the program executed by the computer, the processing of the steps describing the program may be executed in chronological order according to the order described in the present specification, or may be individually executed in parallel or at necessary timing when a call is made, for example. That is, the processing of each step may be executed in an order different from the above-described order as long as no contradiction occurs. Moreover, the processing of the steps describing the program may be executed in parallel with the processing of another program, or may be executed in combination with the processing of another program.

Note that the plurality of present technologies described in the present specification can be implemented independently of one another as a single unit as long as there is no inconsistency. Of course, an arbitrary number of the present technologies can be implemented together. For example, part or whole of the present technology described in any of the embodiments can be implemented in combination with part or whole of the present technology described in another embodiment. Further, part or whole of the above-described arbitrary present technology can be implemented in combination with another technology not described above.

### REFERENCE SIGNS LIST

100 Transform type derivation device
101 Emt control unit
102 Transform set identifier setting unit
103 Transform type candidate table selection unit
104 Transform type setting unit
111 Transform type candidate table A
112 Transform type candidate table B
121 RD cost calculation unit
122 Transform type candidate table switching flag setting unit
200 Image encoding device
201 Control unit
213 Orthogonal transform unit
215 Encoding unit
218 Inverse orthogonal transform unit
261 Primary transform unit
262 Secondary transform unit
271 Primary horizontal transform unit
272 Primary vertical transform unit
281 Transform matrix derivation unit
282 Matrix calculation unit
291 Transform matrix LUT
292 Flip unit
293 Transposition unit
301 Transform matrix derivation unit
302 Matrix calculation unit
311 Transform matrix LUT
312 Flip unit
313 Transposition unit
400 Image decoding device
412 Decoding unit
414 Inverse orthogonal transform unit
461 Inverse secondary transform unit
462 Inverse primary transform unit
471 Inverse primary vertical transform unit
472 Inverse primary horizontal transform unit
481 Transform matrix derivation unit
482 Matrix calculation unit
491 Transform matrix LUT
492 Flip unit
493 Transposition unit
501 Transform matrix derivation unit
502 Matrix calculation unit
511 Transform matrix LUT
512 Flip unit
513 Transposition unit

1. An image processing apparatus comprising:
a decoding unit configured to decode a bitstream to generate coefficient data obtained by orthogonally transforming a prediction residual of an image;
a selection unit configured to select a transform type candidate table corresponding to an encoding parameter from among a plurality of transform type candidate tables having different frequency characteristics of transform type candidates as elements;
a setting unit configured to set a transform type to be applied to a current block, using the transform type candidate table selected by the selection unit; and
an inverse orthogonal transform unit configured to inversely orthogonally transform the coefficient data of the current block generated by the decoding unit, using a transform matrix of the transform type set by the setting unit.

2. The image processing apparatus according to claim 1, wherein
the encoding parameter is a block size of the current block, and
the selection unit selects the transform type candidate table on a basis of the block size.

3. The image processing apparatus according to claim 1, wherein
the encoding parameter is identification information for identifying the transform type candidate table selected in encoding, and
the selection unit selects the transform type candidate table corresponding to the identification information.

4. The image processing apparatus according to claim 1, wherein
the encoding parameter is an inter prediction mode, and
the selection unit selects the transform type candidate table on a basis of whether the inter prediction mode is mono-prediction or bi-prediction.

5. The image processing apparatus according to claim 1, wherein
the encoding parameter is pixel accuracy of a motion vector, and
the selection unit selects the transform type candidate table on a basis of whether a position pointed to by the motion vector is an integer pixel position.

6. The image processing apparatus according to claim 1, wherein the plurality of transform type candidate tables having the different frequency characteristics of the candidates is two transform type candidate tables in which one transform type candidate table has a low-order basis vector having a high-pass characteristic as compared with the other transform type candidate table.

7. The image processing apparatus according to claim 6, wherein
the one transform type candidate table includes at least one of transform types of DST4, DCT4, or DST2 as the candidate, and
the other transform type candidate table includes at least one of transform types of DST7, DCT8, or DST1 as the candidate.

8. The image processing apparatus according to claim 1, wherein
the setting unit selects a transform type from the transform type candidate table selected by the selection unit on a basis of a transform index, and sets the transform type as the transform type to be applied to the current block.

9. The image processing apparatus according to claim 1, wherein
the setting unit respectively sets transform types of inverse one-dimensional orthogonal transform in a horizontal direction and in a vertical direction for the current block.

10. An image processing method comprising:
decoding a bitstream to generate coefficient data obtained by orthogonally transforming a prediction residual of an image;
selecting a transform type candidate table corresponding to an encoding parameter from among a plurality of transform type candidate tables having different frequency characteristics of transform type candidates as elements;
setting a transform type to be applied to a current block, using the selected transform type candidate table; and
inversely orthogonally transforming the coefficient data of the current block generated by decoding the bitstream, using a transform matrix of the set transform type.

11. An image processing apparatus comprising:
a selection unit configured to select a transform type candidate table corresponding to an encoding parameter from among a plurality of transform type candidate tables having different frequency characteristics of transform type candidates as elements;
a setting unit configured to set a transform type to be applied to a current block, using the transform type candidate table selected by the selection unit;
an orthogonal transform unit configured to orthogonally transform a prediction residual of an image, using a transform matrix of the transform type set by the setting unit, to generate coefficient data; and
an encoding unit configured to encode the coefficient data generated by orthogonally transforming the prediction residual by the orthogonal transform unit to generate a bitstream.

12. The image processing apparatus according to claim 11, wherein
the encoding parameter is a block size of the current block, and
the selection unit selects the transform type candidate table on a basis of the block size.

13. The image processing apparatus according to claim 11, wherein
the encoding parameter is an RD cost,
the selection unit selects the transform type candidate table on a basis of the RD cost,
a generation unit configured to generate identification information for identifying the transform type candidate table selected by the selection unit is further included, and
the encoding unit generates the bitstream including the identification information generated by the generation unit.

14. The image processing apparatus according to claim 11, wherein
the encoding parameter is an inter prediction mode, and
the selection unit selects the transform type candidate table on a basis of whether the inter prediction mode is mono-prediction or bi-prediction.

15. The image processing apparatus according to claim 11, wherein
the encoding parameter is pixel accuracy of a motion vector, and
the selection unit selects the transform type candidate table on a basis of whether a position pointed to by the motion vector is an integer pixel position.

16. The image processing apparatus according to claim 11, wherein the plurality of transform type candidate tables having the different frequency characteristics of the candidates is two transform type candidate tables in which one transform type candidate table has a low-order basis vector having a high-pass characteristic as compared with the other transform type candidate table.

17. The image processing apparatus according to claim 16, wherein
the one transform type candidate table includes at least one of transform types of DST4, DCT4, or DST2 as the candidate, and
the other transform type candidate table includes at least one of transform types of DST7, DCT8, or DST1 as the candidate.

18. The image processing apparatus according to claim 11, wherein
the setting unit selects a transform type from the transform type candidate table selected by the selection unit on a basis of a transform index, and sets the transform type as the transform type to be applied to the current block.

19. The image processing apparatus according to claim 11, wherein
the setting unit respectively sets transform types of one-dimensional orthogonal transform in a horizontal direction and in a vertical direction for the current block.

20. An image processing method comprising:
selecting a transform type candidate table corresponding to an encoding parameter from among a plurality of transform type candidate tables having different frequency characteristics of transform type candidates as elements;
setting a transform type to be applied to a current block, using the selected transform type candidate table;
orthogonally transforming a prediction residual of an image, using a transform matrix of the set transform type, to generate coefficient data; and
encoding the coefficient data generated by orthogonally transforming the prediction residual to generate a bitstream.
